(19) United States
(12) Patent Application Publication
(10) Pub. No.: US 2024/0341929 A1
(43) Pub. Date: Oct. 17, 2024

(54) Improved Interproximal Contacts in Dental Restoration Molds

(71) Applicant: 3M INNOVATIVE PROPERTIES COMPANY, St. Paul, MN (US)

(72) Inventors: James D. Hansen, St. Paul, MN (US); Katelyn M. Languell, Eagan, MN (US); Joseph C. Dingeldein, Hudson, WI (US)

(21) Appl. No.: 18/682,504

(22) PCT Filed: Aug. 29, 2022
(86) PCT No.: PCT/IB2022/058082

§ 371 Date: Feb. 9, 2024

Related U.S. Application Data
(60) Provisional application No. 63/238,524, filed on Aug. 30, 2021.

(51) Int. Cl. A61C 13/107; A61C 5/77

(52) U.S. Cl. CPC A61C 13/0001; A61C 5/77

(57) ABSTRACT

A custom tool for forming a dental restoration in a mouth of a patient including a first mold body providing for a customized fit with at least one tooth of the patient, wherein the first mold body includes a portion corresponding with at least a first surface of the tooth and a first interproximal portion corresponding with a first interproximal surface of the tooth and a second interproximal portion corresponding with the second interproximal surface of the tooth, wherein the first interproximal portion of the first mold body and the second interproximal portion of the second mold body each have a patient-specific customized fit, wherein the first mold body and second mold body are configured to combine with the tooth of the patient to form a mold cavity encompassing a portion of missing tooth structure of the tooth, and wherein a first portion of the missing tooth structure includes missing interproximal tooth structure.

### BACKGROUND

A dental restoration, or a dental filling, utilizes a restorative dental material to improve function, integrity and morphology of missing or irregular tooth structure. For example, a dental restoration may be used to restore missing tooth structure due to congenital discrepancies, following external trauma, as part of a restorative treatment for dental caries or tooth decay, or for aesthetic reasons.

Restorative dentistry often includes drilling decay from an infected tooth (commonly referred to as “preparing” the tooth) and then using simple tools and a high level of craftsmanship to isolate, retract, fill and contour the finished restoration. Quality isolation via a rubber dam is cumbersome and often skipped for less effective isolation via cotton rolls-increasing the risk of contamination which reduces longevity of the restoration. Retraction of soft and hard tissue includes manipulation of cords, wedges and matrix bands, and imperfect technique may result in contamination, difficulty in finishing and/or polishing in interproximal areas, and poorly adapted contacts.

While ‘bulk fill’ restorative materials and high intensity curing lights facilitate relatively fast filling of deep cavities (e.g., 4-5 mm), many restorations are completed in a single shade as practitioners may be uncertain of the correct layering protocol for multiple shades or types of restorative material. Last, with little geometrical guidance available on a prepared tooth, creation of the final filling level and occlusal surface geometry may include overfilling with restorative dental material, followed by an iterative process of grinding and checking tooth contact and biting function on an anesthetized patient. This process may be the most time consuming for dental restorations and errors here may result in tooth sensitivity and return visits for adjustment.

Commonly-assigned U.S. Pat. Nos. 10,722,331; 11,185,392, 11,123,165; United States Publ. No. 2019-0083208, and WO Publ. No. 2018/022616, all disclose dental restoration techniques incorporating the molding of dental restorative material directly on a tooth located within the mouth of a patient.

### SUMMARY

This disclosure relates to methods for dental restoration, custom tools used for dental restoration and techniques for producing custom tools for dental restoration In one example, the disclosure is directed to a custom tool for forming a dental restoration in a mouth of a patient. The custom tool comprises: a first mold body providing for a customized fit with at least one tooth of the patient, wherein the first mold body includes a portion corresponding with at least a first surface of the tooth and a first interproximal portion corresponding with a first interproximal surface of the tooth and a second interproximal portion corresponding with the second interproximal surface of the tooth; and a second mold body providing for a customized fit with the at least one tooth of the patient, wherein the second mold body includes a portion corresponding with a second surface of the tooth, and a first interproximal portion corresponding with a first interproximal surface of the tooth and a second interproximal portion corresponding with the second interproximal surface of the tooth, wherein the first interproximal portion of the first mold body and the first interproximal portion of the second mold body each have a patient-specific customized fit and wherein the second interproximal portion of the first mold body and the second interproximal portion of the second mold body each have a patient-specific customized fit, wherein the first mold body and second mold body are configured to combine with the tooth of the patient to form a mold cavity encompassing a portion of missing tooth structure of the tooth, and wherein a first portion of the missing tooth structure includes missing interproximal tooth structure.

In another example, the custom tool comprises: a first mold body providing for a customized fit with at least three teeth of the patient, wherein the first mold body includes a first portion corresponding with at least a first surface of a first tooth and a first interproximal portion corresponding with a first interproximal surface of the first tooth and a second interproximal portion corresponding with the second interproximal surface of the first tooth, wherein the first mold body includes a second portion corresponding with at least a first surface of a second tooth and a first interproximal portion corresponding with a first interproximal surface of the second tooth, wherein the first mold body includes a third portion corresponding with at least a first surface of a third tooth and a first interproximal portion corresponding with a first interproximal surface of the third tooth; and wherein the first interproximal portion and the second interproximal portion of the first mold body each have a patient-specific digitally engineered interproximal portion, wherein the first mold body is configured to combine with the three teeth of the patient to form a mold cavity encompassing a portion of missing tooth structure of the three teeth, and wherein a first portion of the missing tooth structure includes missing interproximal tooth structure of the first interproximal surface of the first tooth and the second interproximal surface of the first tooth.

In another example, the custom tool comprises: a first mold body providing for a customized fit with at least one tooth of the patient, wherein the first mold body includes a portion corresponding with at least a first surface of the tooth and a first interproximal portion corresponding with a first interproximal surface of the tooth and a second interproximal portion corresponding with the second interproximal surface of the tooth; and a second mold body providing for a customized fit with the at least one tooth of the patient, wherein the second mold body includes a portion corresponding with a second surface of the tooth, and a first interproximal portion corresponding with a first interproximal surface of the tooth and a second interproximal portion corresponding with the second interproximal surface of the tooth, wherein the first interproximal portion of the first mold body includes a first region and a second region along the occlusal-gingival axis and wherein the first interproximal portion of the second mold body includes a first region and a second region along the occlusal-gingival axis and wherein the first region of the first interproximal portion of the first mold body is designed to correspond with the first region of the first interproximal portion of the second mold body; and wherein the second region of the first interproximal portion of the first mold body is designed to correspond with the first region of the first interproximal portion of the second mold body.

In yet a further example, this disclosure is directed to another custom tool used for dental treatment. This custom tool comprises: a first mold body providing for a customized fit with at least one tooth of the patient, wherein the first mold body includes a portion corresponding with at least a first surface of the tooth and a first interproximal portion corresponding with a first interproximal surface of the tooth: a second mold body providing for a customized fit with the at least one tooth of the patient, wherein the second mold body includes a portion corresponding with a second surface of the tooth, and a first interproximal portion corresponding with a first interproximal surface of the tooth; wherein the first interproximal portion of the first mold body and the first interproximal portion of the second mold body are substantially offset from one another along the occlusal-gingival axis.

In yet another example, the custom tool comprises: a first mold body providing for a customized fit with at least one tooth of the patient, wherein the first mold body includes a portion corresponding with at least a first surface of the tooth and a first interproximal portion corresponding with a first interproximal surface of the tooth, wherein the first interproximal portion of the first mold body includes a first region and a second region along the occlusal-gingival axis, and wherein the first region has a first thickness measured along the mesial-distal axis and second region has a second thickness measured along the mesial-distal axis and wherein the first thickness is different than the second thickness.

In another example, a custom tool comprises: a first mold body providing for a customized fit with at least one tooth of the patient, wherein the first mold body includes a portion corresponding with at least a first surface of the tooth and a first interproximal portion corresponding with a first interproximal surface of the tooth, a second mold body providing for a customized fit with at least one tooth of the patient, wherein the first mold body includes a portion corresponding with at least a second surface of the tooth and a first interproximal portion corresponding with a first interproximal surface of the tooth, wherein the first interproximal portion of the first mold body has a first thickness measured along a mesial-distal axis and the first interproximal portion of the second mold body has a second thickness measured along a mesial-distal axis, and wherein the first thickness is different than the second thickness.

In another example, a custom tool comprises: a first mold body providing for a customized fit with at least one tooth of the patient, wherein the first mold body includes a portion corresponding with at least a first surface of the tooth and a first interproximal portion corresponding with a first interproximal surface of the tooth: a second mold body providing for a customized fit with at least one tooth of the patient, wherein the second mold body includes a portion corresponding with at least a second surface of the tooth and a first interproximal portion corresponding with the first interproximal surface of the tooth, wherein the first interproximal portion of the first mold body includes a first region, a second region, and a third region along the occlusal-gingival axis and wherein the first interproximal portion of the second mold body includes a first region, a second region, and a third region and wherein the second region of the first interproximal portion of the first mold body includes a portion of an aperture and the second region of the first interproximal portion of the second mold body includes another portion of the aperture.

In another example, a custom tool comprises: a first mold body providing for a customized fit with at least one tooth of the patient, wherein the first mold body includes a portion corresponding with at least a first surface of the tooth and a first interproximal portion corresponding with a first interproximal surface of the tooth, a second mold body providing for a customized fit with the at least one tooth of the patient, wherein the second mold body includes a portion corresponding with at least a second surface of the tooth and a first interproximal portion corresponding with the first interproximal surface of the tooth, wherein the first interproximal portion of the first mold body includes a first region and a second region and wherein the first interproximal portion of the second mold body includes a first region and a second region, wherein the first regions of the first interproximal portion of both the first and second mold bodies includes a first depth measured along the facial-lingual axis, wherein the second regions of the first interproximal portion of both the first and second mold bodies includes a second depth measured along the facial-lingual axis, wherein the second depth is less than the first depth.

In another example, a custom tool comprises: a first mold body providing for a customized fit with at least one tooth of the patient having a first interproximal space and a second interproximal space opposite the first interproximal space, wherein the first mold body includes a portion corresponding with at least a first surface of the tooth and a first interproximal portion corresponding with a first interproximal surface of the tooth and a second interproximal portion corresponding with the second interproximal surface of the tooth, wherein the first interproximal portion of the first mold body includes a thickness measured along the mesial-distal axis and such thickness is narrower than a first interproximal space and the second interproximal portion of the first mold body includes a thickness measured along the mesial distal axis and such thickness is narrower than the second interproximal space measured along the mesial-distal axis, wherein the first mold body is configured to combine with the tooth of the patient to form a mold cavity encompassing a portion of missing tooth structure of the tooth, wherein the first portion of the missing tooth structure includes missing interproximal tooth structure.

In yet another example, a custom tool comprises: a first mold body providing for a customized fit with at least one tooth of the patient, wherein the first mold body includes a portion corresponding with at least a first surface of the tooth and a first interproximal portion corresponding with a first interproximal surface of a scanned three-dimensional image of the tooth of the patient and a second interproximal portion corresponding with the second interproximal surface of a tooth selected or synthesized from geometric data not affiliated with the patient; and a second mold body providing for a customized fit with the at least one tooth of the patient, wherein the second mold body includes a portion corresponding with a second surface of the tooth, a first interproximal portion corresponding with a first interproximal surface of a scanned three-dimensional image of the tooth of the patient and a second interproximal portion corresponding with the second interproximal surface of a tooth selected or synthesized from geometric data not affiliated with the patient; and wherein the first mold body and second mold body are configured to combine with the tooth of the patient to form a mold cavity encompassing a portion of missing tooth structure of the tooth, and wherein a first portion of the missing tooth structure includes missing interproximal tooth structure.

The custom tools and methods described herein may be used in combination with any of the previously described examples to create full, partial, or sequential restorations in the mouth of a patient.

### BRIEF DESCRIPTION OF THE DRAWINGS

FIG. 1 is a perspective view of an embodiment of a prior art custom tool for forming a dental restoration in a mouth of a patient including a facial mold body and a lingual mold body that snap-fit together and combine to form an occlusal surface of the mold;

FIG. 2 is a lingual view of the prior art facial mold body of FIG. 1 in position within the mouth of the patient with the prior art lingual mold body:

FIG. 3 is a view like FIG. 2 except that the prior art facial mold body and lingual mold body are snap fitted together around the teeth to be restored in the mouth of the patient:

FIG. 4 is a lingual view of the patient's teeth after restoration;

FIG. 5A-5I are illustrating example steps in the process of restoring the teeth when using with the prior art custom tool as illustrated in FIGS. 1-3:

FIGS. 6A and 6B are front and back perspective view of one embodiment of a facial mold body of the custom tool of the present invention:

FIGS. 7A and 7B are front and back perspective view of one embodiment of a lingual mold body of the custom tool of the present invention:

FIG. 7C is a top perspective view convenient for showing how the inventive facial mold body of FIGS. 6A and 6B and the inventive lingual mold body of FIGS. 7A and 7B may interlock together to form an embodiment of custom tool of the present invention for forming a dental restoration:

FIG. 8 is a perspective view of one embodiment of the interproximal portions formed together from the facial and the lingual mold bodies illustrated in FIG. 7C;

FIG. 9 is a perspective view of another embodiment of the interproximal portions formed together from the facial and the lingual mold bodies illustrated in FIG. 7C;

FIG. 10 is a perspective view of yet another embodiment of the interproximal portions formed together from the facial and the lingual mold bodies illustrated in FIG. 7C:

FIG. 11 is a perspective view of another embodiment of the interproximal portions of the lingual mold bodies illustrated in FIG. 7C:

FIG. 12 is a perspective view of yet another embodiment of the interproximal portions formed together from the facial and the lingual mold bodies illustrated in FIG. 7;

FIG. 13A-13F are illustrating examples the process of restoring the teeth when using the custom tool as illustrated in FIG. 12;

FIG. 14A-14F are illustrating example steps in the process of restoring the teeth when using the custom tool as illustrated in FIG. 10;

FIG. 15A-15F are illustrating example steps in the process of restoring the teeth when using the custom tool as illustrated in FIG. 11:

FIG. 16A-16F are illustrating example steps in the process of restoring the teeth when using the custom tool as illustrated in FIG. 9;

FIG. 17A-17G are illustrating example steps in the process of restoring the teeth when using the custom tool as illustrated in FIG. 8;

FIG. 18A-18G are illustrating example steps in the process of restoring the teeth when using the custom tool as illustrated in FIG. 12:

FIG. 19A-19F are illustrating example steps in the process of restoring the teeth when using another embodiment of the custom tool;

FIG. 20 illustrates a perspective view of the facial mold body of FIGS. 6A and 6B and the lingual mold body of FIGS. 7A and 7B with an optional hinge:

FIG. 21 is a perspective view of the facial mold body of FIGS. 6A and 6B and the lingual mold body of FIGS. 7A and 7B prior to interlocking them together:

FIGS. 22A and 22B are bottom views convenient for showing how the facial mold body and the lingual mold body of FIG. 21 may interlock together to form an embodiment of custom tool for forming a dental restoration; and

FIG. 23 is a perspective view of the custom tool of FIG. 22b.

The following embodiments are intended to be illustrative of the present disclosure and not limiting.

### DETAILED DESCRIPTION

Restorative dentistry may be used to add tooth structure to a patient's dentition, e.g., to an existing tooth, in order to improve at least one of function, integrity, aesthetics, or morphology of missing or irregular tooth structure. For example, restorative dentistry can be an aesthetic treatment to improve appearance of teeth by, for example, altering their shape and/or optical properties (e.g., shade, translucency), which can be achieved using any suitable technique, such as by applying a veneer, managing position or contour of adjacent soft tissues, lessening or removing a gap between teeth (diastema) and/or resolving the appearance of malposition. As another example, restorative dentistry may be used to adjust the biting or chewing function of teeth to affect tooth function and/or other aspects of overall oral health such as temporomandibular joint (TMJ) disorders, excessive wear, periodontal involvement, gingival recession or as part of a larger plan to construct a healthy and stable oral environment.

In some cases, a dental restoration process includes drilling decay from an infected tooth or reshaping teeth by removing undesired tooth structure (e.g., which may be referred to as “preparing” the tooth) and then using tools and craftsmanship to manually isolate, retract, fill and contour the finished restoration. In other clinical treatments restorative material may be applied onto existing tooth structure with minimal or no preparation.

Different techniques may be used to isolate the dental restoration site. Quality isolation of the dental restoration site via a rubber dam can be cumbersome and may be skipped for less effective isolation via cotton rolls, which may increase the risk of contamination, reduce longevity of the restoration, or both. Retraction of soft and hard tissue may include manipulation of cords, wedges and matrix bands. Imperfect retraction techniques may result in contamination, difficulty in achieving proper tooth contours and symmetry, finishing and/or polishing in interproximal areas, poorly adapted contacts, or any combination thereof.

While “bulk fill” restorative materials and high intensity curing lights may facilitate relatively fast filling of deep cavities (e.g., 4-5 mm), many restorations may be completed in a single shade as practitioners may be uncertain of the correct layering protocol for multiple shades or types of restorative material. Additionally, with little geometrical guidance available on a prepared tooth, creation of the final filling level and occlusal surface geometry may include overfilling with restorative dental material, followed by an iterative process of grinding and checking tooth contact and biting function on an anesthetized patient. This process may be the most time consuming for dental restorations and errors here may result in tooth sensitivity and return visits for adjustment.

The improved tools described herein may include features designed to provide engineered interproximal portions formed between the two primary portions (referred to as “mold portions”) of the tool, which overall helps with providing optimized interproximal spaces between composite molded adjacent teeth. Such interproximal spaces may include contacts providing tight tooth-to-tooth contacts that are easily adjusted to become flossible. Prior art custom molds do not have digitally engineered interproximal portions. In order to separate the two restored teeth from each other to allow a flossible space, the dentist needs to perform a multi-step, time-consuming, and sometimes uncomfortable process of separating the molded teeth with blades or saws to create a new interproximal space between the teeth. In addition, the tools described herein may reduce or eliminate the need for external tools, like wedging means, and are instead self-contained and thus, quicker and simpler to install on a patient's teeth. In addition, the custom tool is digitally designed and fabricated, making them economical to use. Lastly, the tools described herein may reduce flash and/or to allow increased control of the placement of restorative material compared to practitioners using more traditional skills, tools and techniques. By tailoring the specific design criteria by initial tooth interproximal contacts condition, and by optionally additional criteria such as a dentist preference or tooth position, the custom tools of the present invention enable highly predictable results across a wide range of clinical cases.

In addition to benefits to the practitioner and patient, the current invention also provides benefit to the manufacturer(s) of various elements of the digital treatment plan, device design and custom device manufacturer. For instance, by precisely defining the interproximal contact features in fine features of the tool, such as in the interproximal zone, features are cleanly defined voxel by voxel. This makes quality inspection of the tools easier and more definitive than tools designed by simple Boolean operations from tooth data where fine features are dependent on the particular resolution capability of a scanner and/or mill or the printer on any given day.

Further, in the case where the design of the digital wax-up occurs at a manufacturer different from the tool manufacturer, the tool designs of fine interproximal features can allow a predictable clinical experience in the contact region by introducing precise features. These can be applied to the matrix design whether the contacts in the wax-up are large or small. These features can be applied without foreknowledge of the manufacturer of the digital wax-up. In some cases, these adjustments may be applied without foreknowledge of the practitioner.

Rules also can be established by the practitioner ordering the appliance to assure that the interproximal geometry and contact separation experience meets his or her expectation, irrespective of the digital wax-up or tool manufacturer. Customization can occur tooth by tooth based on particular clinical situations to, for instance, extend a designed contact point gingivally in an area which may be susceptible to formation of a black triangle, due to the particular geometry of the hard and soft tissues. An intentionally smaller contact may be placed on teeth that are particularly pain sensitive to the patient.

In some examples, a tool described herein may be digitally designed. For example, a tool may be designed using a three-dimensional (3D) model of the patient's tooth structure (e.g., obtained from an intraoral scan of all or part of the patient's dentition or scanning of a conventional impression or model). The tool can be, for example, manufactured from the digital data using an additive manufacturing technique, such as 3D printing, or a subtractive manufacturing technique, such as CAD/CAM milling.

In some examples, the tool for a dental restoration may include a mold designed based on the 3D model of the patient's tooth structure, and may include additional features to provide advantages over molds that are formed based simply on the 3D scan, a wax-up model, or other molds based simply on the shape of the anatomy and/or desired tooth structure of the patient. The disclosed techniques may facilitate high quality dental restorations with improved quality, reduced flash, reduced time and/or skill requirements compared to conventional manual dental restoration techniques.

Certain example tools for a dental restoration are described in commonly-assigned patents which include: U.S. Pat. Nos. 10,722,331, 11,185,392, 11,123,165, and U.S. patent publication nos. 2020/0306016, 2021/0378789, 2019/0083208, 2019/0298489, 2019/0298489, 2021/0298882, 2022/0117699, 2021/0290349, and 2021/0290349.

FIGS. 1-3 illustrate an embodiment of a prior art facial portion 212 and a prior art lingual portion 230 of the custom tool 210. Specifically, prior art facial portion 212 and prior art lingual portion 230 of the custom tool 210 are described in great detail in U.S. Pat. No. 10,722,331.

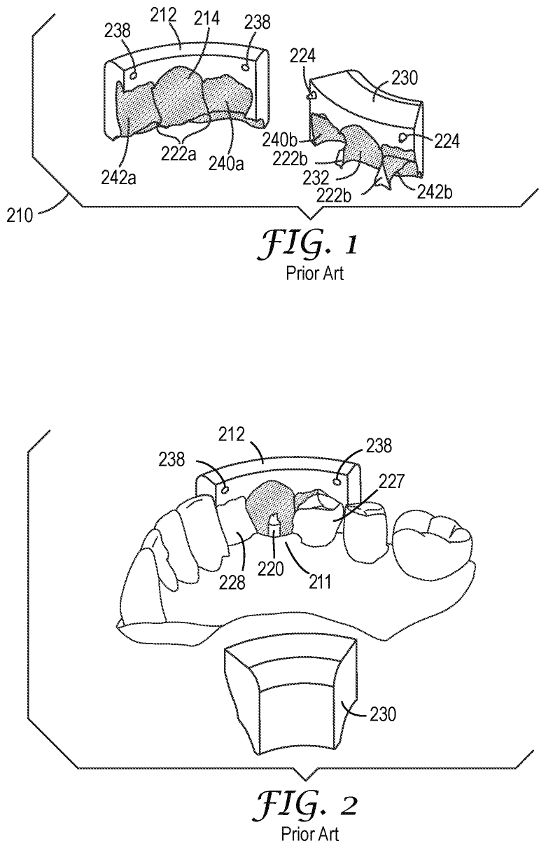

“Facial” as used herein, including the claims, refers to the direction directed toward the cheeks or lips (i.e., the buccal and labial) of the patient, and opposite the lingual direction. “Lingual” as used herein, including the claims, refers to the direction directed toward the tongue of the patient, and opposite the facial direction. FIGS. 2 and 3 illustrate how the prior art facial and lingual portions fit together to form a complete a custom tool 210 for forming a patient-specific dental restoration.

FIGS. 1-4 illustrate custom tool 210 for forming a dental restoration in a mouth of a patient. Custom tool 210 includes a mold body with facial portion 212 and lingual portion 230. Facial portion 212 and lingual portion 230 snap-fit together and combine to define the surfaces of the desired tooth restoration. FIGS. 2 and 3 further illustrate custom tool 210 in combination with teeth 220, 227, 228 within the mouth of a patient. The mouth of the patient further includes gingiva. Tooth 220 includes a significant portion of missing tooth material, and may have been ground down to a tooth stump to remove decayed material to facilitate dental restoration of the entire exposed surface of tooth 220. In some examples a 3D image of the mouth of the patient (or of a dental impression) may be taken prior to the removal of decayed material from tooth 220 as the shape of the decayed material may help in the design of custom tool 210. In the same or different examples, the shape of the contralateral tooth may be mirrored in software, or a design created in a commercially available crown design software, such as 3Shape CAD Design, available from 3Shape of Copenhagen, Denmark, or exocad, available from exocad GMBH of Darmstadt, Germany.

Prior art facial portion 212 forms recesses 238 that are configured to receive protrusions 224 of lingual portion 230 to create the snap-fit connection between facial portion 212 and lingual portion 230.

Facial portion 212 and lingual portion 230 are configured to surround a tooth of a patient. In particular, facial portion 212 forms customized facial surface 214 of the tooth whereas lingual portion 230 forms customized lingual surface 232 of the tooth. Customized facial surface 214 and customized lingual surface 232 include customized proximal surfaces, corresponding to proximal surfaces of the tooth, as well as customized incisal surfaces, corresponding to incisal surfaces of the tooth. Facial portion 212 and lingual portion 230 also form customized gingival surfaces 222a and 222b, respectively, corresponding to gingival surfaces within the mouth of the patient.

The mold body, which includes, facial portion 212 and lingual portion 230 combines with tooth 220, to form a mold cavity. The mold cavity encompasses missing tooth structure of tooth 220. By positioning custom tool 210 over tooth 220, restorative dental material may be positioned into the mold and take the form of the missing tooth structure of tooth 220. In some examples, restorative dental material may be placed on tooth 220 prior to assembling custom tool 210 over tooth 220. In the same or different examples, restorative dental material may be placed on surface 214 of facial portion 212 and/or surface 232 of lingual portion 230 tooth 220 prior to assembling custom tool 210 over tooth 220. In another example, custom tool 210 may be first assembled over tooth 220 and then restorative dental material may be injected into the mold cavity. For example, one or both of facial portion 212 and lingual portion 230 may include a port configured to receive an injection of restorative dental material once custom tool 210 is positioned over tooth 220 to form the mold cavity.

Facial portion 212 and lingual portion 230 are also each configured to register with adjacent teeth within the mouth of the patient to facilitate precise placement within the mouth of the patient. In particular, facial portion 212 and lingual portion 230 form customized surfaces 240a and 240b, respectively, corresponding to the surfaces of the adjacent tooth 126. Facial portion 212 and lingual portion 230 also form customized surfaces 242a and 242b, respectively, corresponding to the surfaces of the adjacent tooth 228. In this manner, facial portion 212 and lingual portion 230 register with teeth 126, 228 to facilitate precise positioning of custom tool 210 within the mouth of the patient for reconstruction of tooth 220.

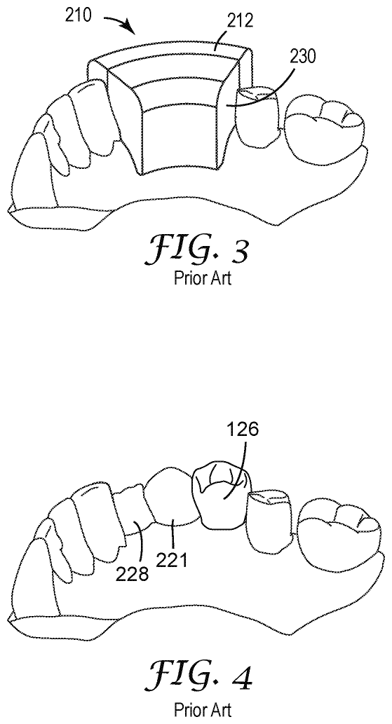

Custom tool 210 facilitates the dental restoration of more than one tooth at the same time. As shown in FIG. 2, tooth 220 is missing a majority of the tooth and tooth 126 is missing just the tooth material on the crown of tooth 126. Custom tool 210 facilitates reconstruction of tooth 126 coincident with the reconstruction of tooth 220. Positioning custom tool 210 over tooth 220 and tooth 126 further forms a second mold cavity representing the missing tooth material on the crown of tooth 126. As described with respect to tooth 220, restorative dental material may be placed within the mold cavity adjacent to tooth 126 in order to facilitate the reconstruction of tooth 126. For example, custom tool 210 may include a second port configured to receive an injection of restorative dental material once custom tool 210 is positioned over tooth 220 to form the mold cavity adjacent to tooth 126. FIG. 4 illustrates repaired tooth 221 (formerly referred to as tooth 220) and teeth 227, 228 within the mouth of a patient following the repair with custom tool 210.

A crown preparation using the custom tool 210 described above was performed on a patient requiring restoration of their lower right cuspid, tooth 220. The prepared crown and neighboring dentition was captured by a full arch digital impression. The digital impression was imported into CAD software and the image of the lower left cuspid was mirrored to form the target restoration shape for the lower right cuspid, tooth 220. The target restoration shape was virtually placed on the crown preparation in the software environment to form the target design for the restored arch. A mold form 210 was then digitally designed in software to encompass the lower right arch form, including the lower right cuspid needing restoration, tooth 220, and the adjacent teeth 227, 228. An optional filling port was digitally subtracted from the cuspid section of the mold form, located in a section of the tooth to be filled in the restoration process. The filling port was located in facial portion 212 and was sized to receive a tip of a commercially available restorative dental material compule gun, to permit injection of the restorative dental material within the mold cavity for tooth 220. A parting line to split the mold form into the facial portion 212 (labial) and lingual portion 230 was determined and alignment features 224, 238 were placed on the two portions 212, 230 to facilitate precise and secure assembly of the physical tool components during the later process of restoring the tooth.

The components within the CAD software, representing facial portion 212 and lingual portion 230, may be converted into a 3D point mesh digital file or other format to facilitate production with a 3D printer, CNC mill, or otherwise. Production of the mold portions 212 and 230 may optionally include other steps such as, curing (e.g., in a UV chamber), cleaning. e.g., in alcohol solution, and other post-processing steps.

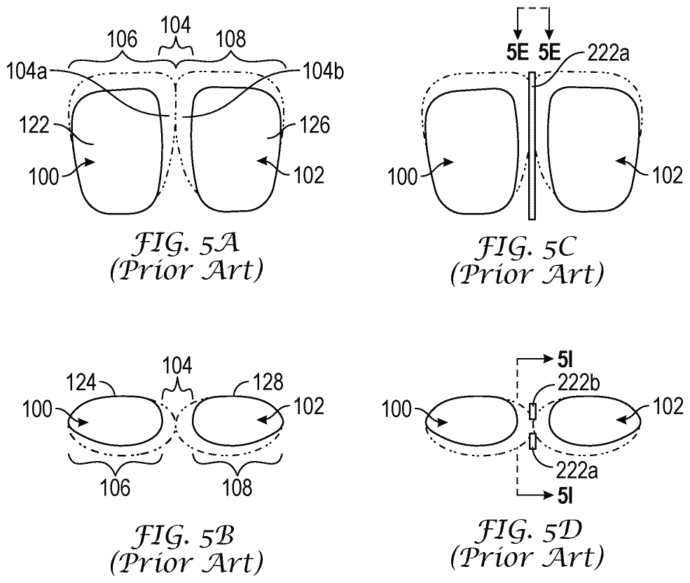

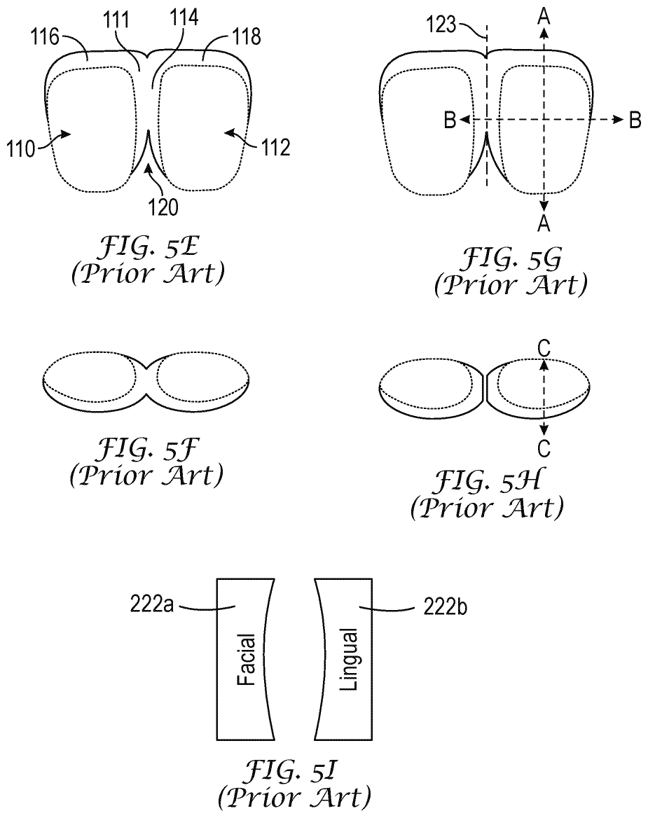

Continuing with the prior art figures, FIGS. 5A-5E illustrate example steps in the process of restoring the teeth when using with the prior art custom tool as illustrated in FIGS. 1-3, except using the two major teeth as example teeth to be restored. In this example, both tooth 100 and tooth 102 are missing portions of their crowns 106, 108 respectively, and the adjacent sides of the two teeth 100, 102 (shown by the missing interproximal structure 104) is also missing. This is illustrated best in FIGS. 5A and 5B. FIG. 5A is a front view of the teeth 100, 102 prior to restoration. FIG. 5B is a top view of the teeth 100, 102 prior to restoration.

FIG. 5C illustrate a front view of the teeth 100, 102 prior to restoration and the interproximal portion 222 which lines up between the two teeth 100, 102. FIG. 5D illustrates a top view of FIG. 5C. FIG. 5D conveniently illustrates the problem with the prior art custom tools. Because there was no detailed consideration of the interproximal area being created, nor the fidelity of the matrix fabrication technology, the interproximal portions within the prior art facial and lingual mold bodies 212, 230 respectively, there was a haphazard gap created between the interproximal portion 222a on the facial mold body 212 and the interproximal portion 222b on the lingual mold body 230. This gap is illustrated by a partial cross-sectional view of the interproximal portions 222a and 222b. As a result, the majority of the interproximal space was filled with a solid portion of dental composite 114, as illustrated in FIGS. 5E and 5F. Therefore, in order to make the teeth flossible, the teeth 228, 221, 227 would subsequently need to be cut or otherwise separated along line 123, as illustrated in FIGS. 5G and 5H. This extensive separation effort can be time consuming for the practitioner, painful for the patient and risks leaving a nonoptimal, or even excessively open, interproximal gap.

FIG. 5I illustrates a partial cross section of the facial interproximal portion 222a and the lingual interproximal portion 222b. This close up helps illustrate how solid portion 114 between teeth 228, 221, 227 is created during the restoration process, and creates the potential problems to finish the molded restoration into a contact that is smooth and flossible between adjacent restored teeth 228, 221, 227.

The present invention provides newly created interproximal portions which are specially engineered to create precise, predictable contacts between teeth. Further, the approach facilitates creation of different configurations or types of interproximal contacts between adjacent restored teeth whenever clinically warranted and/or advantageous in creating a tool to better deliver predictable, flossible interproximal contacts. Each interproximal space between adjacent teeth which are restored by the invention are patient-specific and customized. Each inventive tool of the invention includes at least one patient-specific customized interproximal portions to provide the desired restored interproximal space and/or selected interproximal tooth structure.

The specification describes the restoration of two adjacent teeth having one interproximal space between the two teeth. However, these teachings are not limited to restorations of two teeth and one interproximal space. Rather, multiple teeth may be restored with any number of interproximal spaces restored therebetween. For example, the restorations could include three teeth and two interproximal spaces therebetween. The inventive interproximal protrusions described below are used to restore these interproximal spaces and the teeth.

In FIG. 5G, axis A is convenient for showing the occlusal-gingival axis and is used for measuring length. Axis B is convenient for showing the mesial-distal axis, and is used to measure thickness. Axis C, shown in FIG. 5H, is convenient for showing the facial-lingual axis and is used to measure depth. Although Axis A, B, and C are not included on all the other drawings, they are understood to be used in reference to other teeth in the remaining Figures.

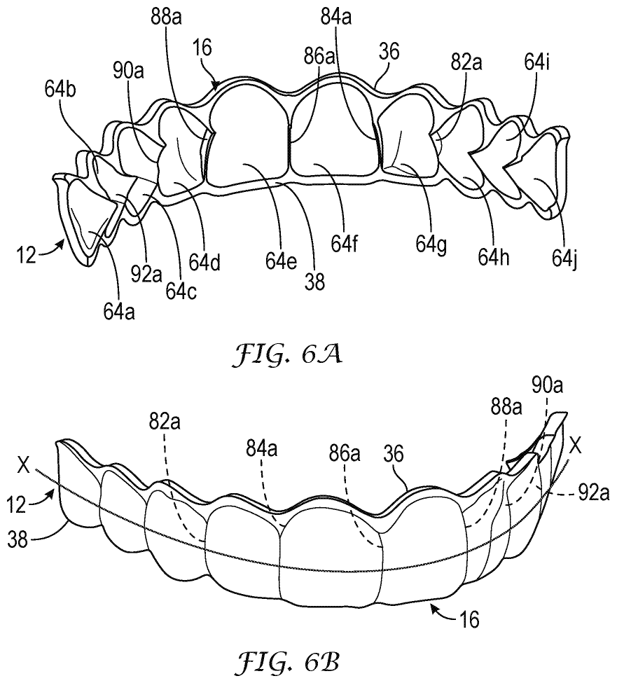

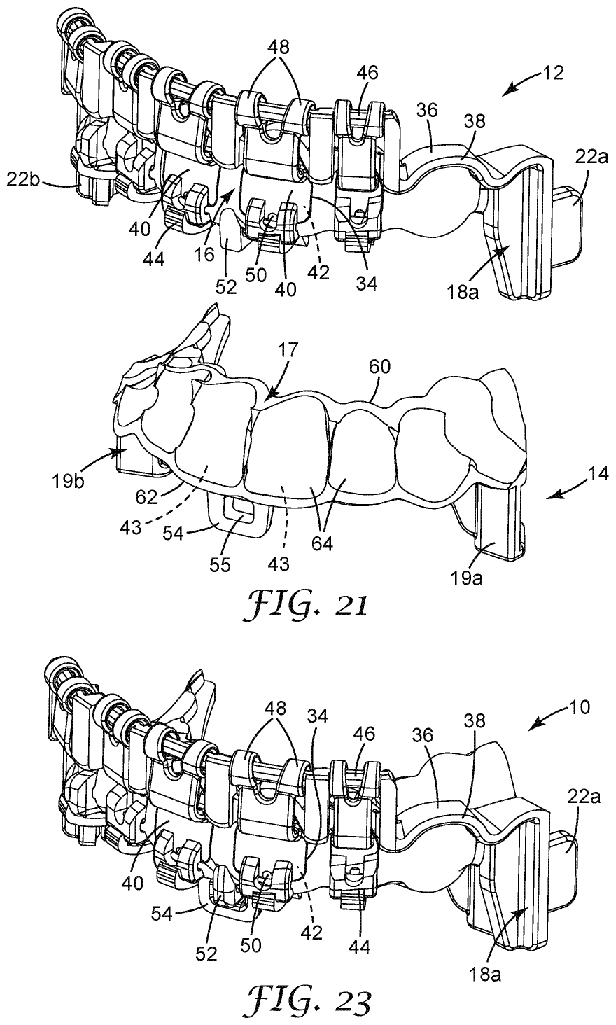

FIGS. 6A and 6B are back and front perspective views of one embodiment of the facial mold body 12 (also referred to as a first mold body) of custom tool 10 for forming a patient-specific dental restoration. The tool 10 includes a facial mold body 12 of the present invention, which may be configured to provide a customized fit with at least one tooth of a patient. For example, facial mold body 12 may be specifically designed to fit next to, mate with, and provide restorative structure to the at least one tooth. In the example shown in FIGS. 6A and 6B, the facial mold body 12 includes a restorative portion 16 and an engagement portion (not shown in FIGS. 6A and 6B, but rather in FIGS. 21 and 23) A practitioner uses the restorative portion 16 of the custom tool to restore at least one tooth in the mouth of the patient.

The facial mold body 12 and lingual mold body 14 may be configured to combine with at least one tooth of the patient to define a mold cavity encompassing at least a portion of desired tooth structure of the tooth or teeth to be restored. For example, in the illustrated example, the facial mold body 12 and lingual mold body 14 may combine with teeth of the patient to define a mold cavity encompassing at least a portion of desired tooth structure for each of the teeth with facial portions. Optionally, each mold cavity may include aligning with apertures 34, as shown in FIGS. 21-23. In some examples, the dental restoration may include a dental veneer restoration on the tooth or teeth to be restored, and the apertures 34 may allow a practitioner to have better control over the placement of restorative material in the mold cavity than a traditional mold. For example, the apertures 34, which align with a majority of a surface of a lingual or facial surface of a tooth may allow a practitioner to have better control over the fill level of the restorative material, as well as the final appearance of that surface, including the final surface texture, shading, and layering of the restorative materials. When door body 40 is mated with a respective aperture 34, inner surface 42 of the door body 40 facing the mold cavity defined by mold body 12 and a tooth structure of a patient may help shape the restorative material that is in the mold cavity. e.g., in order to define the surface of the tooth to be restored.

Thus, in some examples, aperture 34 may be configured to align with a portion comprising a majority of a facial surface of one tooth, and aperture 34 may be configured to align with a portion comprising a majority of a facial surface of another tooth. In other examples, apertures 34 may be configured to align with a portion less than the majority of a surface of a tooth, e.g., when smaller areas of the tooth are being restored and/or when expected flow of the restorative dental material from outside mold body 12 and through apertures 34 to the part of the mold cavity defined by mold body 12 proximate the tooth surface needing restoration is deemed to be sufficient. In some examples, the shape of one or more of apertures 34 may be designed to substantially match the shape of the tooth and/or the portion of the tooth to be restored. For example, apertures 34 may be substantially noncircular. In other examples, however, the shape of one or more apertures 34 may be circular. In other examples the doors or mold bodies may include injection ports 226 designed to mate closely with a dispensing tip of a dental restorative material device.

In the illustrated example in FIGS. 21-23 including apertures 34, door body 40 may also include a vent 50. The vent 50 may be configured to allow excess restorative material to flow out of a mold cavity, which may be removed prior to curing (e.g., with a scalar instrument), providing for easier removal of flash. Alternatively, or in addition, vent 50 may be configured to allow air to flow out of the mold cavity.

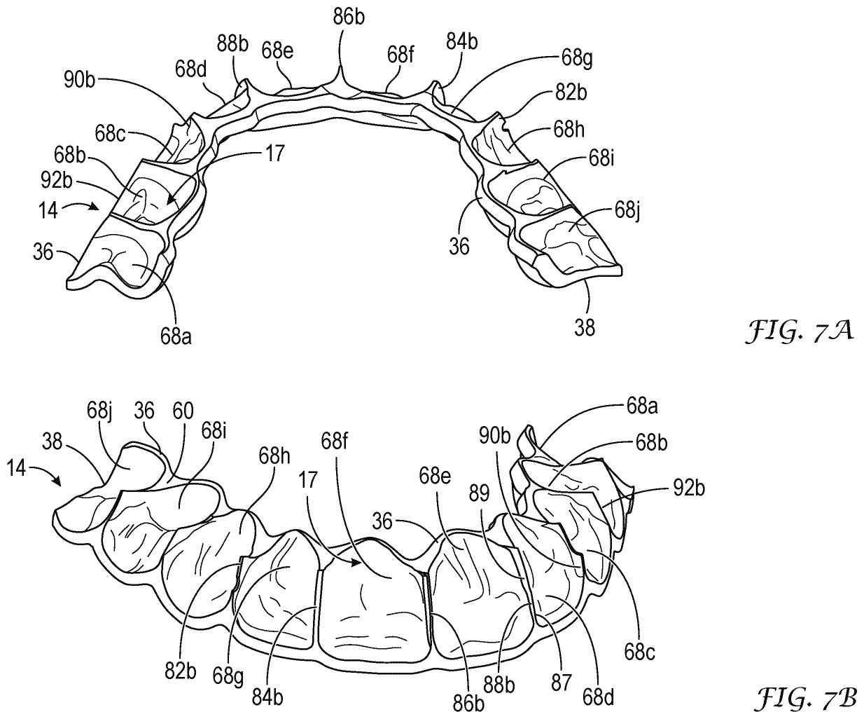

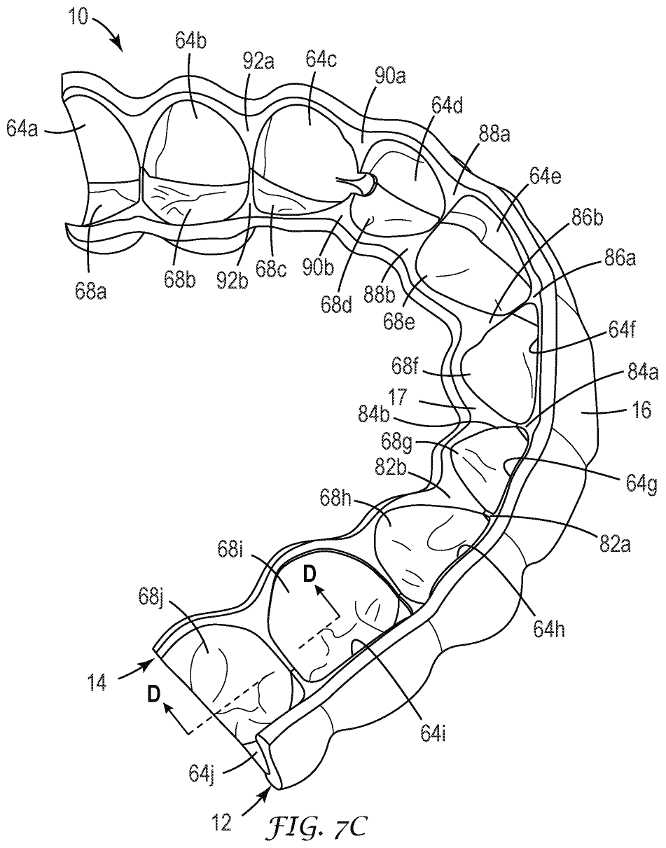

Returning to FIGS. 6A and 7A, the facial mold body 12 may include a custom gingival surface 36 that is generally contoured to match the gingiva, but not engaging the gingiva. This allows excess restoration material to be cleanly removed at the gingival margin prior to curing. The facial mold body 12 may also include an occlusal or incisal surface 38.

The facial mold body 12 includes the inventive interproximal portions between adjacent interior mold surfaces 64. Various embodiments of the interproximal portions 82, 84, 86, 88, 90, 92 are included in one facial mold body 12 for illustration purposes. However, it is contemplated that the mold bodies 12, 14 may include only one embodiment or multiple embodiments of the interproximal portions 82, 84, 86, 88, 90, 92. The interproximal portions are selected to provide certain interproximal tooth structure between adjacent selected teeth. As such then each patient may include patient-specific, customized fitted interproximal portions. At least some of the interproximal portions are specifically engineered, and are not mere replications of the interproximal structure that was previously present in the scan of the patient's mouth before restoration or in the digitized wax-up. Instead, they are digitally engineered to provide a specific, selected interproximal tooth structure in the interproximal spaces, after the dental restoration material 111 fills the mold and is subsequently cured.

Interproximal portion 82a is located between interior mold surfaces 64g and 64h. Interproximal portion 84a is located between interior mold surfaces 64f and 64g. Interproximal portion 86a is located between interior mold surfaces 64e and 64f. Interproximal portion 88a is located between interior mold surfaces 64d and 64e. Interproximal portion 90a is located between interior mold surfaces 64c and 64d. Interproximal portion 92a is located between interior mold surfaces 64b and 64c. Other interior mold surfaces 64a. 64i, and 64j are also included in the embodiment of the facial mold body 12.

FIGS. 7A and 7B show front and back perspective views of one embodiment of a lingual mold body 14 (also referred to as second mold body) of the custom tool of the present invention for forming a patient-specific dental restoration. The custom tool 10 includes a lingual mold body 14 of the present invention, which may be configured to provide a customized fit with at least one tooth of a patient. For example, facial mold body 14 may be specifically designed to fit next to, mate with, and provide restorative structure to the at least one tooth. In the example shown in FIGS. 7A and 7B, the lingual mold body 14 includes a restorative portion 17 and may include an optional an engagement portion 18 (shown in FIGS. 21-23). A practitioner uses the restorative portion 16 of the custom tool to restore at least one tooth in the mouth of the patient.

The lingual mold body 14 includes the inventive interproximal portions between adjacent interior mold surfaces 68. The lingual mold body 14 includes the complimentary interproximal portions 82b, 84b, 86b, 88b, 90b, 92b engineered or designed to mate with the interproximal portions 82a, 84a. 86a, 88a. 90a, 92a of the facial mold body 12. Various embodiments of the interproximal portions 82b, 84b. 86b, 88b, 90b, 92b are included in one lingual mold body 14 for illustration purposes. However, it is contemplated that the mold bodies 12, 14 may include only one embodiment or multiple embodiments of the interproximal portions 82, 84, 86, 88, 90, 92.

Interproximal portion 82b is located between interior mold surfaces 68g and 68h. Interproximal portion 84b is located between interior mold surfaces 68f and 68g. Interproximal portion 86b is located between interior mold surfaces 68e and 68f. Interproximal portion 88b is located between interior mold surfaces 68d and 68e Interproximal portion 90b is located between interior mold surfaces 68c and 68d. Interproximal portion 92a is located between interior mold surfaces 64b and 64c. Other interior mold surfaces 64a, 64i, and 64j are also included in the embodiment of the facial mold body 12.

FIG. 7C is a top perspective view convenient for showing how the inventive facial mold body of FIGS. 6A and 6B and the inventive lingual mold body of FIGS. 7A and 7B may interlock together to form an embodiment of custom tool of the present invention for forming a dental restoration. As mentioned above, the interproximal portions 82 of the facial mold body 12 mate with the interproximal portions 82 of the lingual mold body 14. For instance, interproximal portion 82a is designed to correspond with, or more preferably to mate with interproximal portion 82b; interproximal portion 82a is designed to correspond with, or more preferably to mate with interproximal portion 82b: interproximal portion 84a is designed to correspond with, or more preferably to mate with interproximal portion 84b; interproximal portion 86a is designed to correspond with, or more preferably to mate with interproximal portion 86b: interproximal portion 88a is designed to correspond with, or more preferably to mate with interproximal portion 88b; interproximal portion 90a mates with interproximal portion 90b; and interproximal portion 92a is designed to correspond with, or more preferably to mate with interproximal portion 92b. Each interproximal portion is specially designed and customized for the individual patient's interproximal portions between individual teeth to be restored.

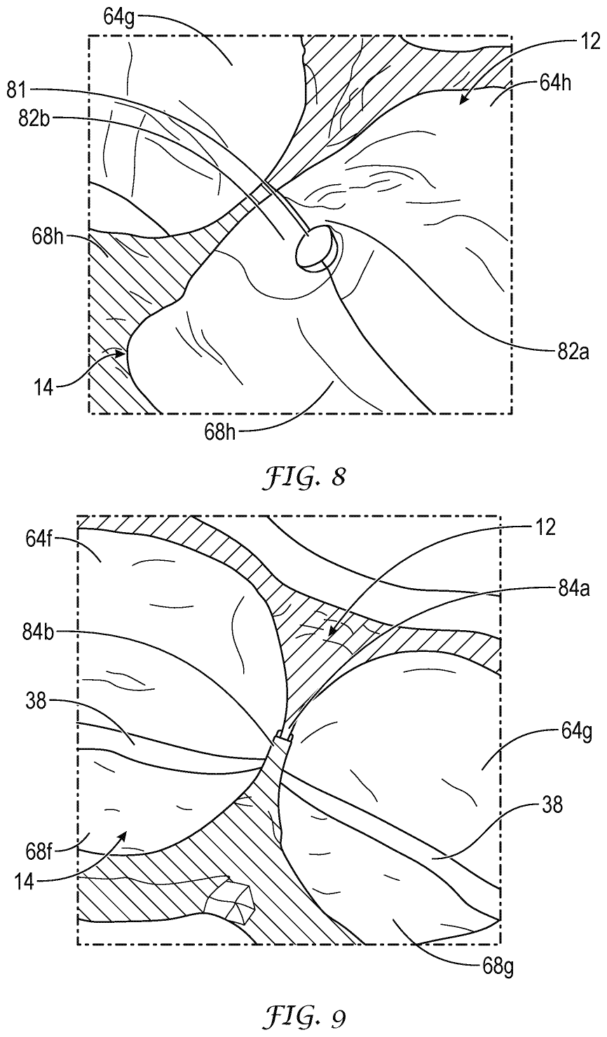

FIGS. 8-12 each illustrate a different embodiment of the inventive interproximal portions 82. Although not illustrated, the lingual and facial mold bodies may also be formed as a one monolithic mold body structure, provided the interproximal portion thickness(es) and material used can accommodate elastic placement of the one-piece mold body onto the teeth prior to filling and that the mold body can be removed (as a single piece or in parts) after the restorative material is cured.

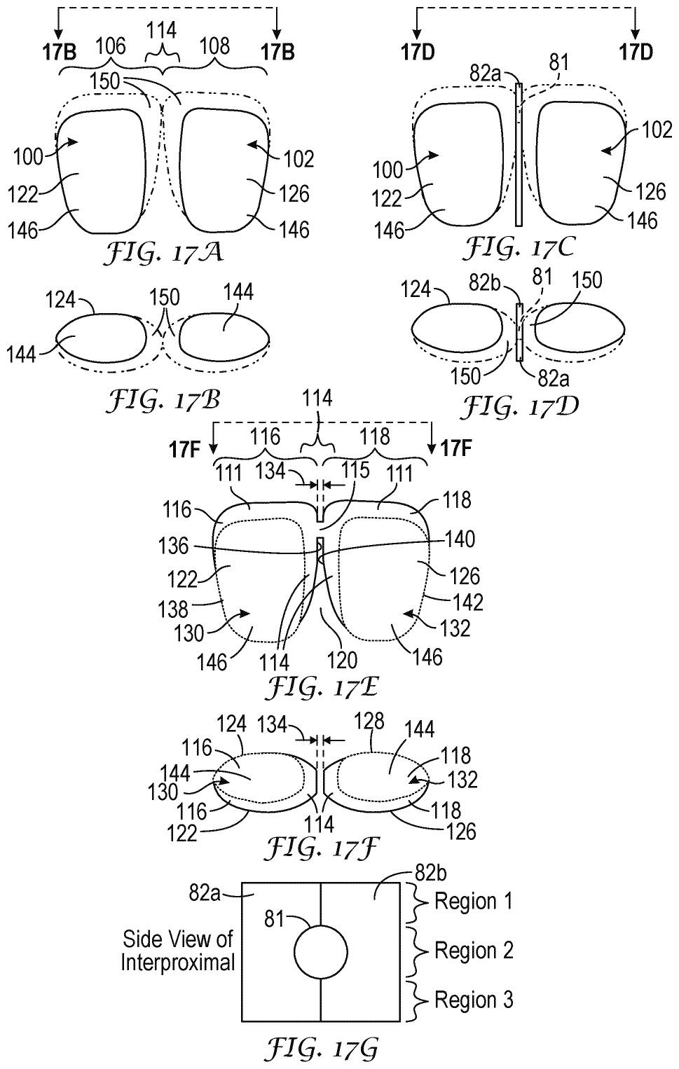

FIG. 8 illustrates a first embodiment of interproximal portion 82. Interproximal portion 82 is formed by the interproximal portion 82a of the facial mold body 12 and the interproximal portion 82b of the lingual mold body 14. Preferably, the interproximal portions 82a, 82b mate together to form separate mold cavities for adjacent teeth. The mold cavities encompass missing tooth structure of one or both of the adjacent teeth. Interproximal portion includes the unique embodiment of an aperture 81 formed between portions 82a, 82b. Each portion 82a, 82b includes a curved surface and two planar surfaces, which then provide aperture 81. Another way to describe the embodiment of interproximal portions 82a. 82b is to describe them as have a first region, a second region and a third region. The second region includes the aperture 81, while the first and second regions include the two planar surfaces which mate together respectively or are matched planar portions. The aperture 81 conveniently provides the mold to receive the dental restoration material 111 and form the interproximal portion 115 after the material 111 is cured, as shown in FIG. 17E. The interproximal portion 115 is later fractured or cut by the dentist to allow floss to pass though between the restored teeth 130 and 132. Example steps used to perform the restoration process using this embodiment of interproximal portion 82 are illustrated in FIGS. 17A-17G.

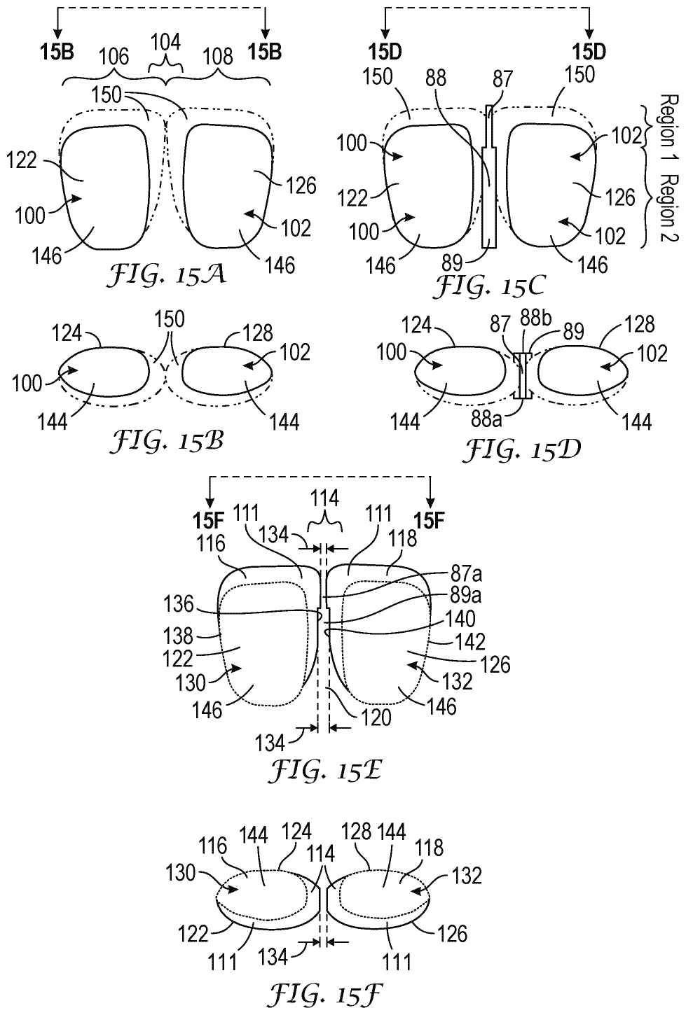

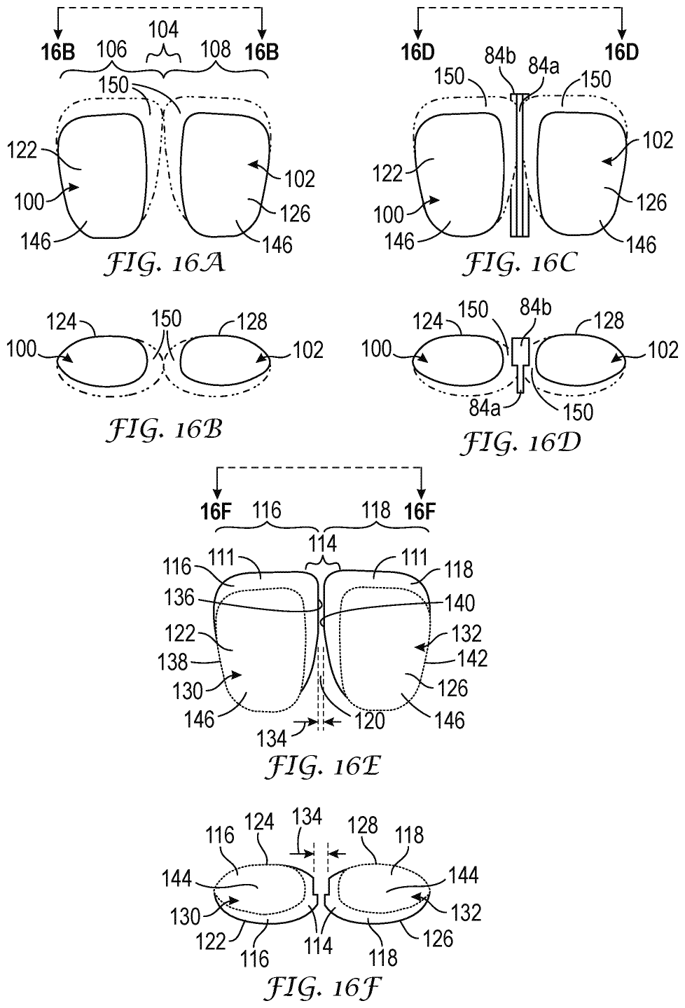

FIG. 9 illustrates a second embodiment of interproximal portion 84. Interproximal portion 84 is formed by the interproximal portion 84a of the facial mold body 12 and the interproximal portion 84b of the lingual mold body 14. Preferably, the interproximal portions 84a. 84b mate together to form separate mold cavities for adjacent teeth. The mold cavities encompass missing tooth structure of one or both of the adjacent teeth. Interproximal portion includes the unique embodiment of different thicknesses between the portions 84a, 84b. Interproximal portion 84a of the first mold body (facial mold body) 12 has a first thickness measured along the mesial-distal axis, and the first interproximal portion 84b of the second mold body (lingual mold body) 14 has a second thickness measured along the mesial-distal axis. In a preferred arrangement, the first thickness is less than the second. However, in another embodiment the first thickness could be more than the second thickness. Example steps used to perform the restoration process using this embodiment of interproximal portion 84 are illustrated in FIGS. 16A-16F.

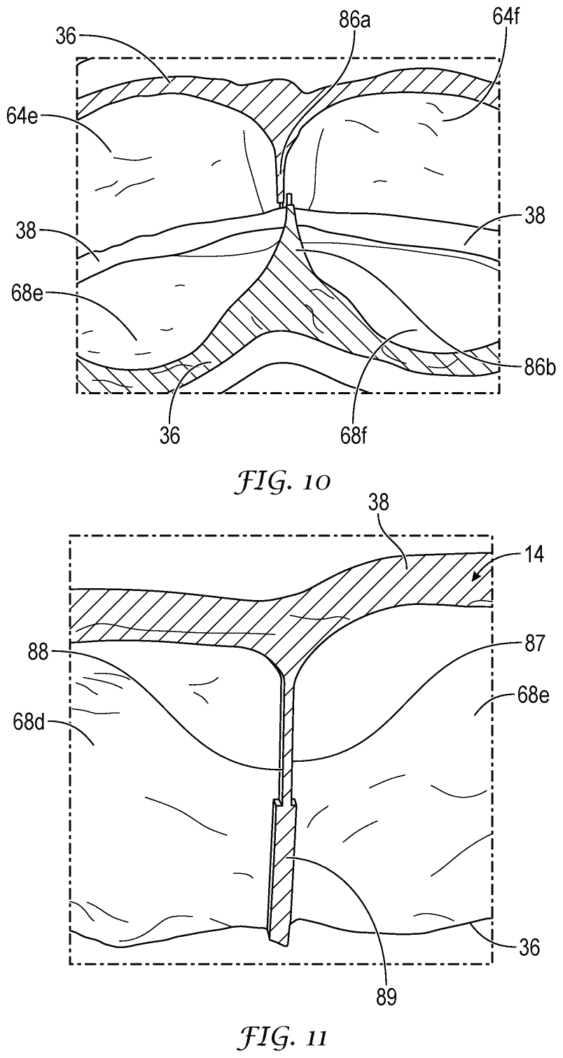

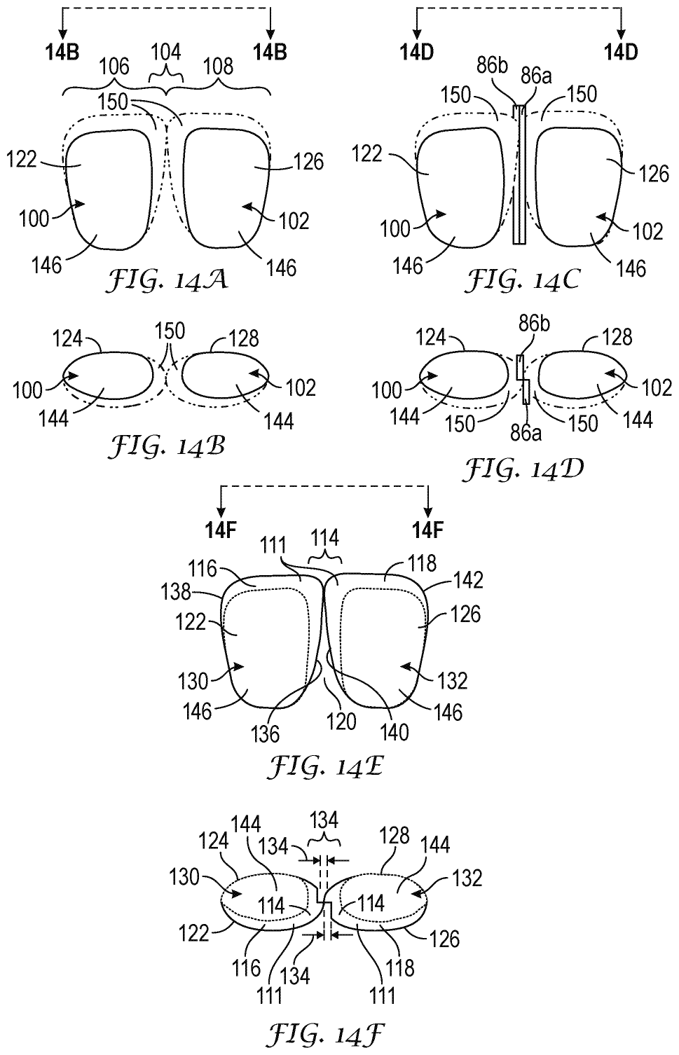

FIG. 10 illustrates a third embodiment of interproximal portion 86. Interproximal portion 86 is formed by the interproximal portion 86a of the facial mold body 12 and the interproximal portion 86b of the lingual mold body 14. Preferably, the interproximal portions 86a. 86b mate together to form separate mold cavities for adjacent teeth. The mold cavities encompass missing tooth structure of one or both of the adjacent teeth. Interproximal portion includes the unique embodiment of the portions 86a, 86b being offset from one another. First interproximal portion 86a of the first mold body (facial mold body) 12 and the first interproximal portion 86b of the second mold body (lingual mold body) 14 are substantially or completely offset from one another along the occlusal-gingival axis. In other words, the interproximal portions 86a. 86b are not aligned with one another. Interproximal portion 84a of the first mold body (facial mold body) 12 has a first thickness measured along the mesial-distal axis, and the first interproximal portion 84b of the second mold body (lingual mold body) 14 has a second thickness measured along the mesial-distal axis. In a preferred arrangement, the first thickness is approximately the same or substantially the same as the second thickness. However, in another embodiment the first thickness could be more or less than the second thickness. Example steps used to perform the restoration process using this embodiment of interproximal portion 86 are illustrated in FIGS. 14A-14F. In another embodiment, if first interproximal portion 86a of the first mold body 12 and first interproximal portion 86b of the second mold body 14 were aligned with one another along the occlusal-gingival axis and both have the same thickness measured along the mesial-distal axis, this embodiment would be the same as or similar to the interproximal portions 92a, 92b described below.

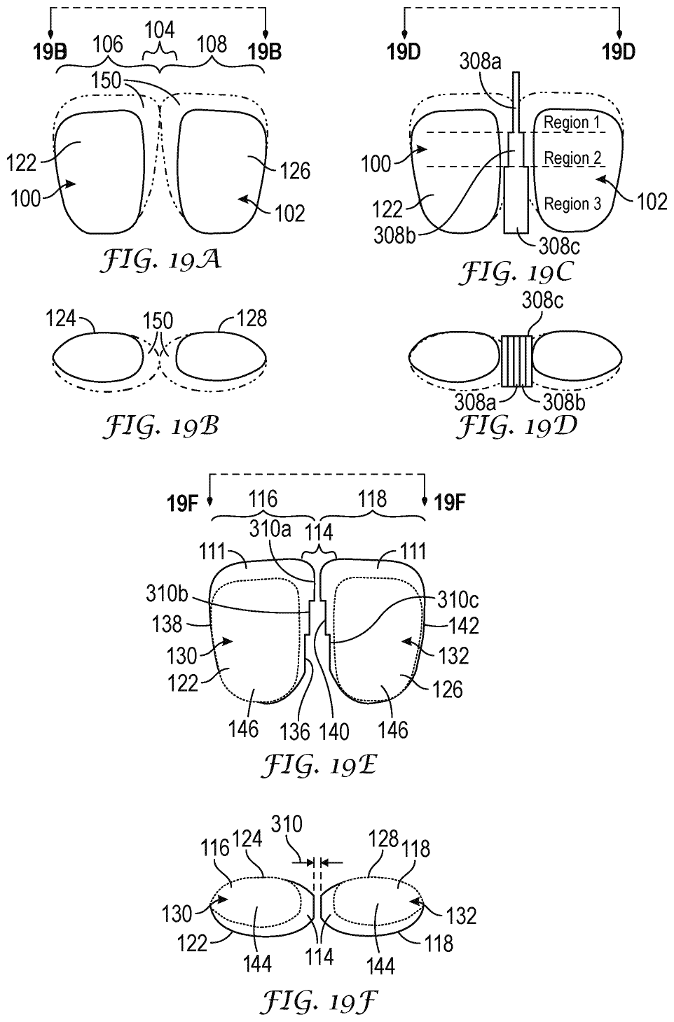

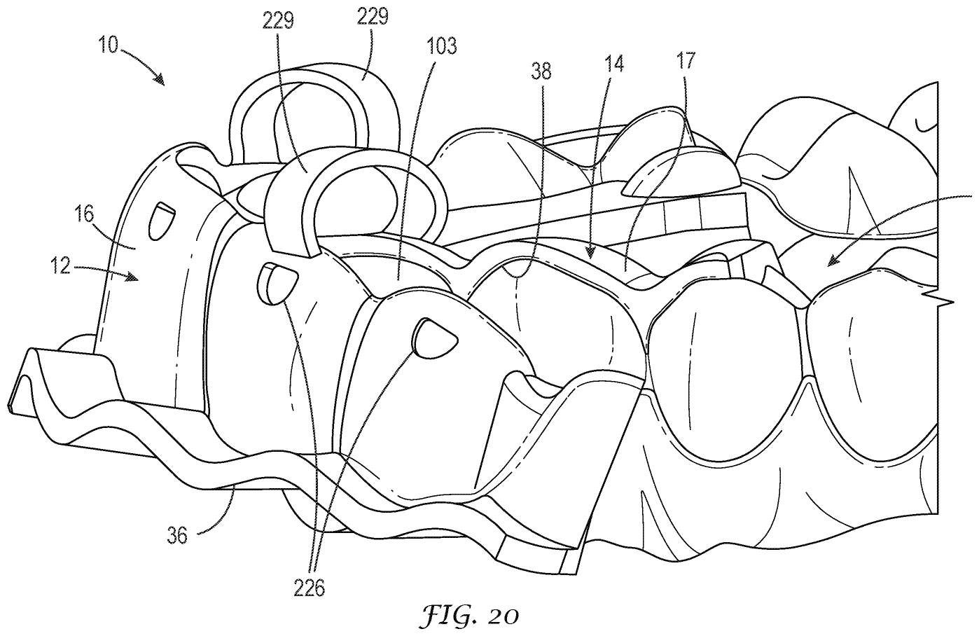

FIG. 11 illustrates a fourth embodiment of interproximal portion 88. Interproximal portion 88 is formed by the interproximal portion 88a of the facial mold body 12 and the interproximal portion 88b of the lingual mold body 14. FIG. 11 illustrate only the interproximal portion 88b for clarity. Preferably, the interproximal portions 88a. 88b mate together to form separate mold cavities for adjacent teeth. The mold cavities encompass missing tooth structure of one or both of the adjacent teeth. Interproximal portion includes the unique embodiment of the portions 88a, 88b where the first interproximal portion 88a of the first mold body (facial mold body) 12 includes a first region 87 and a second region 89 along the occlusal-gingival axis. The first region 87 includes a first thickness measured along the mesial-distal axis and the second region 89 includes a second thickness measured along the mesial-distal axis. In the embodiment illustrated in FIG. 11, the first thickness is less than the second thickness. In another arrangement (not illustrated), the first thickness is could be more than the second thickness. Example steps used to perform the restoration process using this embodiment of interproximal portion 88 are illustrated in FIGS. 15A-15F. In yet another arrangement, the interproximal portions 308 could include three or more regions, 308a, 308b, 308c, as illustrated in FIGS. 19C and 19D. Such interproximal portion 308 include varying thicknesses from thinnest (308a) to thickest (308c).

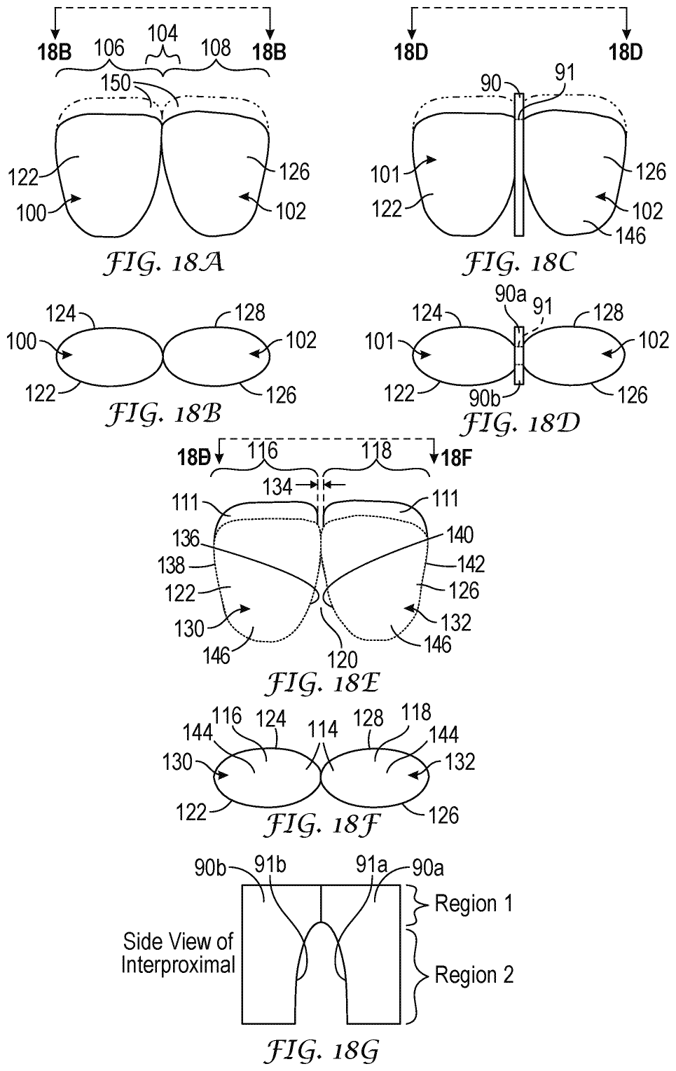

FIG. 12 illustrates a fifth embodiment of interproximal portion 90. Interproximal portion 90 is formed by the interproximal portion 90a of the facial mold body 12 and the interproximal portion 90b of the lingual mold body 14. Preferably, the interproximal portions 90a. 90b mate together to form separate mold cavities for adjacent teeth. The mold cavities encompass missing tooth structure of one or both of the adjacent teeth. Interproximal portion includes the unique embodiment of the portions 90a, 90b where the first interproximal portion 90a of the first mold body (facial mold body) 12 includes a curved surface 91 along the occlusal-gingival axis. Example steps used to perform the restoration process using this embodiment of interproximal portion 90 are illustrated in FIGS. 18A-18G.

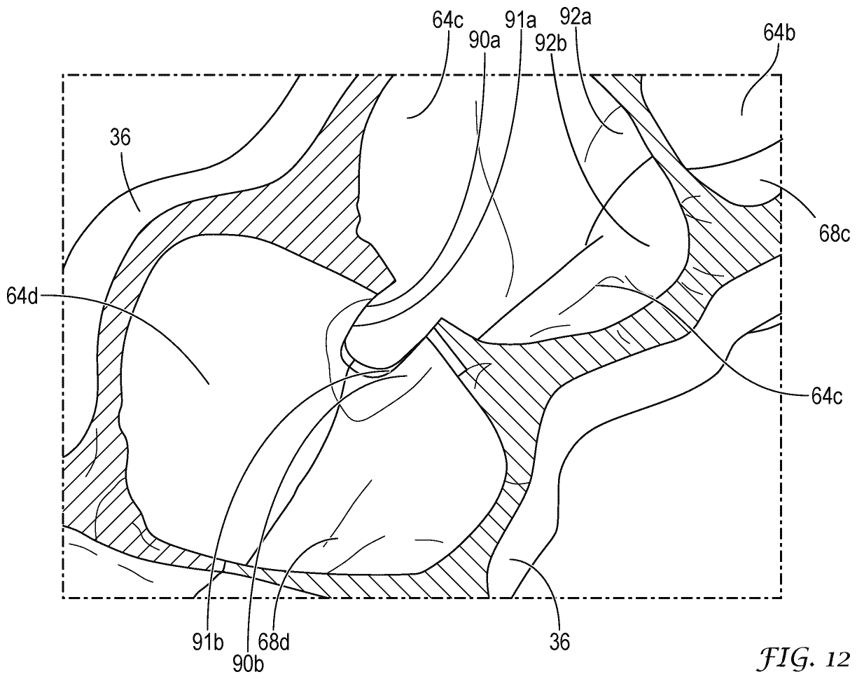

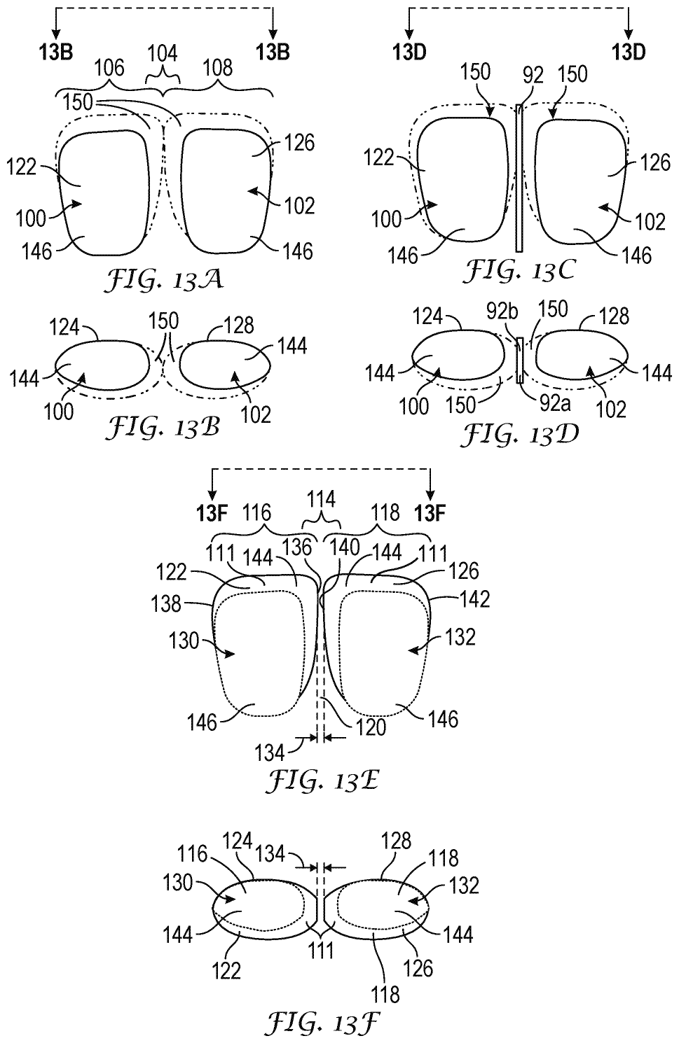

FIG. 12 also illustrates a sixth embodiment of interproximal portion 92 Interproximal portion 92 is formed by the interproximal portion 92a of the facial mold body 12 and the interproximal portion 92b of the lingual mold body 14. Preferably, the interproximal portions 92a. 92b mate together to form separate mold cavities for adjacent teeth. The mold cavities encompass missing tooth structure of one or both of the adjacent teeth. Interproximal portion includes the unique embodiment of the portions 92a, 92b where the first interproximal portion 92a of the first mold body (facial mold body) 12 is aligned along the occlusal-gingival axis with the first interproximal portion 92b of the second mold body (lingual mold body) 14. In a preferred version, the interproximal portion 92a of the first mold body 12 includes a first thickness measured along the mesial-distal axis and the first interproximal portion 92b of the second mold body 14 includes a second thickness measured along the mesial-distal axis, and wherein the first thickness is approximately the same as the second thickness. Example steps used to perform the restoration process using this embodiment of interproximal portion 92 are illustrated in FIGS. 13A-13F.

FIGS. 13 through 19 are convenient for illustrating use and benefits of the different embodiments of the interproximal portions of the present invention discussed above. For each scenario, the teeth 100, 102 to be restored are configured the same to clearly illustrate the differences between the interproximal contacts formed between the restored teeth 130, 132. However, this should not be considered limiting. The interproximal portions may be used with any combination of teeth to be restored having very different portions missing. Features of the interproximal portions may also vary along the length of the portion where, for instance, the gingival section of the interproximal portion contact may have a different configuration than the occlusal portion of the interproximal contact.

In particular embodiments, the interproximal portion includes a length measured along the occlusal-gingival axis (axis A) and a thickness measured along the mesial-distal axis (axis B), where the length to thickness ratio is greater than 5. In other particular embodiments, the interproximal portion includes a length measured along the occlusal-gingival axis (axis A) and a depth measured along the facial-lingual axis (axis C), where the length to depth ratio is greater than 5.

FIGS. 13A-13F illustrate the use of the interproximal portion 92. Interproximal portion 92 is made from the interproximal portion 92a in the first mold body (facial mold body) 12 and the interproximal portion 92b of the second mold body (lingual mold body) 14. The interproximal portions 92a. 92b are designed to align with each other along the occlusal-gingival axis and preferably have the same thickness measured along the mesial-distal axis. FIG. 13A illustrates a front view of the first tooth 100 and second tooth 102 that are to be restored, showing missing portions 150. FIG. 13B illustrates a top view of the first tooth 100 and second tooth 102 that are to be restored, showing missing portions 150. Both teeth 100, 102 are missing crown portions, referred to generally as missing portions 106, 108 and missing interproximal portion 104. When the first mold body 12 and second mold body 14 combine with the teeth 100, 102 to be restored, they form a cavity to be filled with dental restoration material 11l to restore the teeth to their intended state. When combined, interproximal portions 92a. 92b together form the interproximal portion 92 spaced equidistant between the teeth 100, 102, as shown in FIGS. 13C and 13D. After the dental restoration material is injected or placed into the cavity and thereafter cured, the mold bodies 12, 14 are removed, presenting a first restored tooth 130 and a second restored tooth 132, as illustrated in the front side and top view of the teeth in FIGS. 13E and 13F, respectively. The restored teeth structure on the first tooth 130 is referred to generally as restored tooth structure 116, and the restored teeth structure on the second tooth 132 is referred generally as restored tooth structure 118. The first restored tooth 130 now has a restored crown portion 116 and interproximal portion 114, including a new occlusal or incisal region 144, a new mesial interproximal surface 136, and a new distal proximate surface 138, a complete first or facial surface 122 of the tooth 130, a complete second or lingual surface 124 of the tooth, along with the original gingival portion 146 of the tooth 130. Likewise, the second restored tooth 132 now has a restored crown portion 118 and interproximal portion 114, including a new occlusal or incisal region 144, a new mesial interproximal surface 140, a new distal proximate surface 142, a complete first or facial surface 126 of the tooth 132, a complete second or lingual surface 128 of the tooth, along with the original gingival portion 146 of the tooth 132. Take note the interproximal contact now provided between the adjacent restored teeth 130, 132, which includes a specifically engineered space 134 in the interproximal space between the teeth, including an interproximal embrasure 120. No additional steps are necessary by the dentist, as the space 134 provided adequate space for floss to travel between the two teeth 130, 132 to the gum line. In a preferred embodiment, the space 134 measures in the range of 10 to 1000 μm along the mesial-distal axis. In one preferred embodiment, the space 134 measures approximately 150 μm. The thickness of typical dental floss is approximately 120 μm. One skilled in the art could vary this dimension depending on tooth type, tooth anatomy, doctor preference, resolution of the 3D printer, the structural integrity, and ability to place the desired feature. Therefore the space 134 is wide enough to allow typical dental floss to easily pass between adjacent teeth. In addition, the interproximal portions themselves may also be as thin as 10 to 1000 μm along the mesial-distal axis, with one preferred embodiment of approximately 150 μm. Commercially available 3D printers have the ability to print such embodiments. One example of a suitable commercially available printer is the ProX 800 3D printer available from 3D Systems based in Rock Hill, South Carolina.

FIGS. 14A-14F illustrate the use of the interproximal portion 86. Interproximal portion 86 is made from the interproximal portion 86a in the first mold body (facial mold body) 12 and the interproximal portion 86b of the second mold body (lingual mold body) 14. The interproximal portions 86a, 86b are designed to offset from each other along the mesial-distal axis and preferably have the same thickness measured along the mesial-distal axis. FIG. 14A illustrates a side view of the first tooth 100 and second tooth 102 that are to be restored. FIG. 14B illustrates a top view of the first tooth 100 and second tooth 102 that are to be restored, showing missing portions 150. Both teeth 100, 102 are missing crown portions, referred to generally as missing portions 106, 108 and missing interproximal portion 104. When the first mold body 12 and second mold body 14 combine with the teeth 100, 102 to be restored, they form a cavity to be filled with dental restoration material 111 to restore the teeth to their intended state. When combined, interproximal portions 86a. 86b together form the interproximal portion 86 spaced between the teeth 100, 102, as shown in FIGS. 14C and 14D. After the dental restoration material is injected or placed into the cavity and thereafter cured, the mold bodies 12, 14 are removed, presenting a first restored tooth 130 and a second restored tooth 132, as illustrated in the front and top view of the teeth in FIGS. 14E and 1314F, respectively. The restored teeth structure on the first tooth 130 is referred to generally as restored tooth structure 116, and the restored teeth structure on the second tooth 132 is referred generally as restored tooth structure 118. The first restored tooth 130 now has a restored crown portion 116 and interproximal portion 114, including a new occlusal or incisal region 144, a new mesial interproximal surface 136, and a new distal proximate surface 138, a complete first or facial surface 122 of the tooth 130, a complete second or lingual surface 124 of the tooth, along with the original gingival portion 146 of the tooth 130. Likewise, the second restored tooth 132 now has a restored crown portion 118 and interproximal portion 114, including a new occlusal or incisal region 144, a new mesial interproximal surface 140, a new distal proximate surface 142, a complete first or facial surface 126 of the tooth 132, a complete second or lingual surface 128 of the tooth, along with the original gingival portion 146 of the tooth 132. Take note the interproximal contact now provided between the adjacent restored teeth 130, 132, which includes a specifically engineered space 134 in the interproximal space between the teeth, including an interproximal embrasure 120. No additional steps are necessary by the dentist, as the space 134 provided adequate space for floss to travel between the two teeth 130, 132 to the gum line. Because there would be no straight-line gap between the teeth, sliding floss between the teeth would still provide visual and haptic feedback to the dentist, indicating a closed contact. In a preferred embodiment, the space 134 measures 150 microns along the mesial-distal axis, which indicates the thickness of the individual interproximal portions 86a, 86b would then each measure 75 microns. In another preferred embodiment, the space 134 measures 300 microns along the mesial-distal axis, which indicates the thickness of the individual interproximal portions 86a, 86b would then each measure 150 microns. Because those portions 86a, 86b are offset by that same amount in the mesial-distal axis, the resulting visible space between tooth 130 and 132 would be zero when viewed facially.

FIGS. 15A-15F illustrate the use of the interproximal portion 88. Interproximal portion 86 is made from the interproximal portion 88a in the first mold body (facial mold body) 12 and the interproximal portion 88b of the second mold body (lingual mold body) 14. The interproximal portions 88a, 88b are each designed to have different thicknesses from each other measured along the mesial-distal axis and extending generally along the occlusal-gingival axis. Each portion 88a, 88b have a corresponding first region 87 and second region 89. The first region 87 includes a first thickness measured along the mesial-distal axis and the second region 89 includes a second thickness measured along the mesial-distal axis. In the illustrated embodiment, the first thickness is less than the second thickness. FIG. 15A illustrates a side view of the first tooth 100 and second tooth 102 that are to be restored. FIG. 15B illustrates a top view of the first tooth 100 and second tooth 102 that are to be restored, showing missing portions 150. Both teeth 100, 102 are missing crown portions, referred to generally as missing portions 106, 108 and missing interproximal portions 104. When the first mold body 12 and second mold body 14 combine with the teeth 100, 102 to be restored, they form a cavity to be filled with dental restoration material 111 to restore the teeth to their intended state. When combined, interproximal portions 88a. 88b together form the interproximal portion 88 spaced between the teeth 100, 102, as shown in FIGS. 15C and 15D. After the dental restoration material is injected or placed into the cavity and thereafter cured, the mold bodies 12, 14 are removed, presenting a first restored tooth 130 and a second restored tooth 132, as illustrated in the front and top view of the teeth in FIGS. 15E and 15F, respectively. The restored teeth structure on the first tooth 130 is referred to generally as restored tooth structure 116, and the restored teeth structure on the second tooth 132 is referred generally as restored tooth structure 118. The first restored tooth 130 now has a restored crown portion 116 and interproximal portion 114, including a new occlusal or incisal region 144, a new mesial interproximal surface 136, and a new distal proximate surface 138, a complete first or facial surface 122 of the tooth 130, a complete second or lingual surface 124 of the tooth, along with the original gingival portion 146 of the tooth 130. Likewise, the second restored tooth 132 now has a restored crown portion 118 and interproximal portion 114, including a new occlusal or incisal region 144, a new mesial interproximal surface 140, a new distal proximate surface 142, a complete first or facial surface 126 of the tooth 132, a complete second or lingual surface 128 of the tooth, along with the original gingival portion 146 of the tooth 132. Take note the interproximal contact now provided between the adjacent restored teeth 130, 132, which includes a specifically engineered space 134 in the interproximal space between the teeth, including an interproximal embrasure 120. The engineered space 134 is the result of the interproximal portion 88, including a first region shaped to correspond with the first region 87 and a second region shaped to correspond with the second region 89. No additional steps are necessary by the dentist, as the space 134 provided adequate space for floss to travel between the two teeth 130, 132 to the gum line. In a preferred embodiment, the first region interproximal space 134 has a length that measures one-third to one-half of the total tooth height along the occlusal-gingival axis and has a thickness that measures 150 microns along the mesial-distal axis. Also in this preferred embodiment, the second region interproximal space 134 has a length that measures one-half to two-thirds of the total tooth height measured along the occlusal-gingival axis and has a thickness that measures 150 microns along the mesial-distal axis.

FIGS. 16A-16F illustrate the use of the interproximal portion 84. Interproximal portion 84 is made from the interproximal portion 84a in the first mold body (facial mold body) 12 and the interproximal portion 84b of the second mold body (lingual mold body) 14. The interproximal portions 84a, 84b are each designed to have different thicknesses from each other measured along the mesial-distal axis and extending along the occlusal-gingival axis. The interproximal portion 84a includes a first thickness measured along the mesial-distal axis. The interproximal portion 84b includes a second thickness measured along the mesial-distal axis. In the illustrated embodiment, the first thickness is less than the second thickness. FIG. 16A illustrates a front view of the first tooth 100 and second tooth 102 that are to be restored. FIG. 16B illustrates a top view of the first tooth 100 and second tooth 102 that are to be restored, showing missing portions 150. Both teeth 100, 102 are missing crown portions, referred to generally as missing portions 106, 108 and an interproximal portions 104. When the first mold body 12 and second mold body 14 combine with the teeth 100, 102 to be restored, they form a cavity to be filled with dental restoration material 111 to restore the teeth to their intended state. When combined, interproximal portions 84a. 84b together form the interproximal portion 84 spaced between the teeth 100, 102, as shown in FIGS. 16C and 16D. After the dental restoration material is injected or placed into the cavity and thereafter cured, the mold bodies 12, 14 are removed, presenting a first restored tooth 130 and a second restored tooth 132, as illustrated in the front and top view of the teeth in FIGS. 16E and 16F, respectively. The restored teeth structure on the first tooth 130 is referred to generally as restored tooth structure 116, and the restored teeth structure on the second tooth 132 is referred generally as restored tooth structure 118. The first restored tooth 130 now has a restored crown portion 116 and interproximal portion 114, including a new occlusal or incisal region 144, a new mesial interproximal surface 136, and a new distal proximate surface 138, a complete first or facial surface 122 of the tooth 130, a complete second or lingual surface 124 of the tooth, along with the original gingival portion 146 of the tooth 130. Likewise, the second restored tooth 132 now has a restored crown portion 118 and interproximal portion 114, including a new occlusal or incisal region 144, a new mesial interproximal surface 140, a new distal proximate surface 142, a complete first or facial surface 126 of the tooth 132, a complete second or lingual surface 128 of the tooth, along with the original gingival portion 146 of the tooth 132. Take note the interproximal contact now provided between the adjacent restored teeth 130, 132, which includes a specifically engineered space 134 in the interproximal space between the teeth, including an interproximal embrasure 120. The engineered space 134 is the result of the interproximal portion 84, including a first region shaped to correspond with the first interproximal portion 84a and a second region shaped to correspond with the second interproximal portion 84b. No additional steps are necessary by the dentist, as the space 134 provided adequate space for floss to travel between the two teeth 130, 132 to the gum line. In a preferred embodiment, the first region interproximal space 134 has a thickness that measures 150 microns along the mesial-distal axis. Also in this preferred embodiment, the second region interproximal space 134 has a thickness that measures greater than the thickness of interproximal portion 84a along the mesial-distal axis. One none limited example would be where interproximal portion 84b is two to three times thicker than interproximal portion 84a.

FIGS. 17A-17G illustrate the use of the interproximal portion 82. Interproximal portion 82 is made from the interproximal portion 82a in the first mold body (facial mold body) 12 and the interproximal portion 82b of the second mold body (lingual mold body) 14. The interproximal portions 82a, 82b are each designed to have matching thicknesses from each other measured along the mesial-distal axis and extending along the occlusal-gingival axis. The interproximal portions 82a, 82b each include includes a half of an aperture 81, and together form the full aperture 81. FIG. 17A illustrates a side view of the first tooth 100 and second tooth 102 that are to be restored. FIG. 17B illustrates a top view of the first tooth 100 and second tooth 102 that are to be restored, showing missing portions 150. Both teeth 100, 102 are missing crown portions, referred to generally as missing portions 106, 108 and an interproximal portions 104. When the first mold body 12 and second mold body 14 combine with the teeth 100, 102 to be restored, they form a cavity to be filled with dental restoration material 111 to restore the teeth to their intended state. When combined, interproximal portions 82a, 82b together form the interproximal portion 82 spaced between the teeth 100, 102, as shown in FIGS. 17C and 17D.

After the dental restoration material is injected or placed into the cavity and thereafter cured, the mold bodies 12, 14 are removed, presenting a first restored tooth 130 and a second restored tooth 132, as illustrated in the front and top views of the teeth in FIGS. 17E and 17F, respectively. The restored teeth structure on the first tooth 130 is referred to generally as restored tooth structure 116, and the restored teeth structure on the second tooth 132 is referred generally as restored tooth structure 118. The first restored tooth 130 now has a restored crown portion 116 and interproximal portion 114, including a new occlusal or incisal region 144, a new mesial interproximal surface 136, and a new distal proximate surface 138, a complete first or facial surface 122 of the tooth 130, a complete second or lingual surface 124 of the tooth, along with the original gingival portion 146 of the tooth 130. Likewise, the second restored tooth 132 now has a restored crown portion 118 and interproximal portion 114, including a new occlusal or incisal region 144, a new mesial interproximal surface 140, a new distal proximate surface 142, a complete first or facial surface 126 of the tooth 132, a complete second or lingual surface 128 of the tooth, along with the original gingival portion 146 of the tooth 132. Take note the interproximal contact now provided between the adjacent restored teeth 130, 132, which includes a specifically engineered space 134 in the interproximal space between the teeth, including an interproximal embrasure 120 and a cylinder-shaped portion 115. The engineered space 134 is the result of the interproximal portion 82, including the dental restorative material 111 that flowed through and was subsequently cured within aperture 81. Additional steps are necessary by the dentist, as the cylinder-shaped portion 115 in space 134 must be first cut or fractured to provide adequate space for floss to travel between the two teeth 130, 132 to the gum line. In a preferred embodiment, the interproximal space 134 has a thickness that measures 150 microns (μm) along the mesial-distal axis. Also in this preferred embodiment, the cylinder-like portion has a length that measures from 1-5 mm along the occlusal-gingival axis and a depth that measures from 0.5-2.5 mm along the facial-lingual axis. These ranges of values for these measurements could be increased or decreased based on things like tooth type/location, tooth anatomy, and doctor preference. The values for size, shape and location also could consider anatomical norms, which for instance have been reported by Sarig, et al. in Clin Oral Invest 17:731-738 (2013).

FIG. 17G is provided to provide more clarity on the shape and size of the aperture 81. While depicted as circular or oval, the cross-section contact may be a more complex geometry based on anatomical measurements, clinician preference and/or other engineering data that optimizing the strength, profiles and/or aesthetics of the interproximal contact. In this embodiment, the resulting interproximal structure may need to be separated by the dentist to create two adjacent teeth. Thus the circular or oval portion 115 would be preferably cut or removed to allow dental floss to pass through easily between the adjacent teeth. Alternatively, sufficiently small and/or narrow contact areas may separate under forces of mold removal and/or very light interproximal manipulation of the teeth with a hand instrument (e.g., a Hollenback carver).

FIGS. 18A-18G illustrate the use of the interproximal portion 90. Interproximal portion 90 is made from the interproximal portion 90a in the first mold body (facial mold body) 12 and the interproximal portion 90b of the second mold body (lingual mold body) 14. The interproximal portions 90a. 90b are each designed to have a curved surface 91 in the form of an arch, which extends from the mesial-distal axis and extends along the occlusal-gingival axis. The interproximal portions 90a, 90b each includes a half of an arch-shaped curved surface 91a, 91b, and together form the curved surface 91, as illustrated in FIG. 18G. The interproximal portions 90a, 90b each include a planar surface that correspond, or more preferably mate together, in a first region. The interproximal portions 90a, 90b each include the arch-shaped curved surface 91a, 91b in a second region.

FIG. 18A illustrates a side view of the first tooth 100 and second tooth 102 that are to be restored. FIG. 18B illustrates a top view of the first tooth 100 and second tooth 102 that are to be restored, showing missing portions 150. Both teeth 100, 102 are missing crown portions, referred to generally as missing portions 106, 108 and an interproximal portion 104. When the first mold body 12 and second mold body 14 combine with the teeth 100, 102 to be restored, they form a cavity to be filled with dental restoration material 111 to restore the teeth to their intended state. When combined, interproximal portions 90a. 90b together form the interproximal portion 90 spaced between the teeth 100, 102, as shown in FIGS. 18C and 18D. After the dental restoration material is injected or placed into the cavity and thereafter cured, the mold bodies 12, 14 are removed, presenting a first restored tooth 130 and a second restored tooth 132, as illustrated in the front and top view of the teeth in FIGS. 18E and 18F, respectively. The restored teeth structure on the first tooth 130 is referred to generally as restored tooth structure 116, and the restored teeth structure on the second tooth 132 is referred generally as restored tooth structure 118. The first restored tooth 130 now has a restored crown portion 116 and interproximal portion 114, including a new occlusal or incisal region 144, a new mesial interproximal surface 136, and a new distal proximate surface 138, a complete first or facial surface 122 of the tooth 130, a complete second or lingual surface 124 of the tooth, along with the original gingival portion 146 of the tooth 130. Likewise, the second restored tooth 132 now has a restored crown portion 118 and interproximal portion 114, including a new occlusal or incisal region 144, a new mesial interproximal surface 140, a new distal proximate surface 142, a complete first or facial surface 126 of the tooth 132, a complete second or lingual surface 128 of the tooth, along with the original gingival portion 146 of the tooth 132. Take note the interproximal contact now provided between the adjacent restored teeth 130, 132, which includes a specifically engineered space 134 in the interproximal space between the teeth, including an interproximal embrasure 120. The engineered space 134 is the result of the interproximal portion 90, which may be sized to accommodate an existing contact between two teeth or it may be sized to include the dental restorative material 111 that flowed through and was subsequently cured within curved surface 91. In a preferred embodiment, the thickness of engineered space measures 150 microns along the mesial-distal axis FIG. 18G is provided to provide more clarity on the shape and size of the curved surface 91a. 91b. This embodiment of interproximal portion 90 is particularly helpful in cases where tooth crowns are being lengthened and there is a need to prevent the formation of an excessively large cross section of bonded composite between the teeth.

FIGS. 19A-19F illustrate the use of the interproximal portion 308. Interproximal portion 308 was not previously illustrated in FIGS. 6-12. Interproximal portion 308 is made from the interproximal portion 308a. 308b, 308c in the first mold body (facial mold body) 12 and the interproximal portion 308a, 308b, 308c of the second mold body (lingual mold body) 14. The interproximal portions 308a. 308b, 308c are each designed to have different thicknesses from each other measured along the mesial-distal axis and different lengths along the occlusal-gingival axis. The interproximal portions 308 each include three regions, 308a. 308b, 308c as illustrated in FIG. 19C. The first region 308a is an occlusal region, which is located closest to the occlusal or incisal region of the tooth to be restored. The third region 308c is a gingival region, which is located closest to the gingiva of the patient. The second region 308b is a middle region, located between the occlusal region 308a and gingival region 308c. The first region 308a has a first thickness, the second region 308b as a second thickness, and the third region 308c has a third thickness, all measured along the mesial-distal axis. In one embodiment, all the thicknesses are different from one another. In the illustrated embodiment the first thickness is less than the second thickness, and the second thickness is less than the third thickness.

FIG. 19A illustrates a front view of the first tooth 100 and second tooth 102 that are to be restored. FIG. 19B illustrates a top view of the first tooth 100 and second tooth 102 that are to be restored, showing missing portions 150. Both teeth 100, 102 are missing crown portions and facial portions, referred to generally as missing portions 106, 108 and an interproximal portion 104. When the first mold body 12 and second mold body 14 combine with the teeth 100, 102 to be restored, they form a cavity to be filled with dental restoration material 11l to restore the teeth to their intended state. When combined, interproximal portions 308a, 308b. 308c together form the interproximal portion 308 spaced between the teeth 100, 102, as shown in FIGS. 19C and 19D. After the dental restoration material is injected or placed into the cavity and thereafter cured, the mold bodies 12, 14 are removed, presenting a first restored tooth 130 and a second restored tooth 132, as illustrated in the front and top view of the teeth in FIGS. 19E and 19F, respectively. The restored teeth structure on the first tooth 130 is referred to generally as restored tooth structure 116, and the restored teeth structure on the second tooth 132 is referred generally as restored tooth structure 118. The first restored tooth 130 now has a restored crown portion 116 and interproximal portion 114, including a new occlusal or incisal region 144, a new mesial interproximal surface 136, and a new distal proximate surface 138, a new facial surface 122 of the tooth 130, a complete second or lingual surface 124 of the tooth, along with the original gingival portion 146 of the tooth 130. Likewise, the second restored tooth 132 now has a restored crown portion 118 and interproximal portion 114, including a new occlusal or incisal region 144, a new mesial interproximal surface 140, a new distal proximate surface 142, a new facial surface 126 of the tooth 132, a complete second or lingual surface 128 of the tooth, along with the original gingival portion 146 of the tooth 132. Take note the interproximal contact now provided between the adjacent restored teeth 130, 132, which includes a specifically engineered space 310 in the interproximal space between the teeth, including an interproximal embrasure 120 and a stepped portion. The engineered space 310 is the result of the interproximal portion 308: more specifically, the engineered spaces 310a, 310b 310c are the result of interproximal portions 308a, 308b, 308c. In a preferred embodiment, the stepped portion has a thickness that measures 150 microns, 175 microns. 200 microns along the mesial-distal axis and a length that measures one-third the total tooth height, one-third the total tooth height, and one-third the total tooth height along the occlusal-gingival axis for regions 1, 2 and 3, respectively.

As mentioned above the first mold body (facial mold body) 12 and second mold body (lingual mold body) 14 are configured to combine with the at least one tooth of the patient to form the mold cavity. For example, facial mold body 12 and lingual mold body 14 may be configured to mate with one another and/or to be attached to the at least one tooth to form the mold cavity. The facial mold body 12 and the lingual mold body 14 are illustrated as two separate portions that are mated together within the patient's mouth. However, the facial mold body 12 and lingual mold body 14 may alternatively be formed as a one-piece, monolithic, integrally formed mold body.

The facial mold body 12 may include forms recesses 238 that are configured to receive protrusions 224 of lingual portion 14 to create the snap-fit connection between facial portion 12 and lingual portion 14. Examples of such recesses 238 and protrusions 224 are illustrated in FIG. 1. Alternatively, or in addition to, the custom mold 10 may include a hinge or plurality of hinges 229 for assisting in the mold bodies 12, 14 to engage tightly and in alignment with the teeth in the mouth of the patient 70. For this embodiment, the hinge 229 is illustrated in FIG. 20. A further example that is not illustrated is for the facial and lingual mold body to be a single unitary structure that can flex over the height of contours of the teeth. This becomes possible when the body is constructed of a sufficiently elastic material and may optionally include multiple flexors or a single living hinge along the incisal edge.

In the example shown in FIGS. 21-23, the lingual mold body 14 includes a restorative portion 17 and an engagement portion 19. A practitioner uses the restorative portion 17 of the custom tool to restore at least one tooth in the mouth of the patient. In some examples, lingual mold body 14 is separable from and engageable with the facial mold body 12, while maintaining the integrity of the respective mold bodies, through use of their engagement portions 18, 19. Examples of engagement portions is explained below. Such engagement portions 18, 19 may be used in lieu of or in conjunction with recesses 238 and protrusions 224 or hinge 229.

In the illustrated embodiment, there are two engagement portions 19a, 19b positioned at opposite ends of the restorative portion 17, which is located between the engagement portions 19a. 19b. This is ideal, but not necessary. For example, the lingual mold body 14 could include just one engagement portion 19 positioned adjacent the restorative portion 17. In tools having two engagement portions 19a, 19b, this provides two points of interlock between the facial and lingual mold bodies 12, 14, respectively.

Lingual mold body 14 includes first engagement portion 19a and second engagement portions 19b. The engagement portions 19a, 19b of the lingual mold body 14 are structured to engage with or interlock with the engagement portions 18a, 18b on the facial mold body 12, as explained in more detail below in reference to FIGS. 7, 8, and 9.

The first engagement portion 19a and second engagement portion 19b both extend away from the restorative portion. In the illustrated embodiment, the engagement portions 19 extend at a generally right angle relative to the restorative portion 17. When compared to the patient's mouth, which includes an occlusal plane illustrated as reference line X-X (shown in FIG. 6B), the engagement portions 19 extend generally perpendicular to the occlusal plane.

As illustrated in FIGS. 21-23, engagement portions 19 of the lingual mold body 14 may include a variety of engagement surfaces configured to mate appropriately with the engagement surfaces 24, 26, 28 on the facial mold body 12. Engagement portions 19a, 19b of the lingual mold body 14 may include an indentation 30a. 30b respectively or some other mechanism known in the art for interlocking with the facial mold body 12. In the illustrated embodiment, indentation 30 includes a first engagement surface 31, a second engagement surface 32, and a third engagement surface 33. Indentations 30a, 30b are sized and shaped to interlock or snap fit with the protrusions 20a, 20b in the facial mold body 12. Various structures known in the art may be substituted for the indentations 30 and protrusion 20, so long as they assist in securely interlocking the lingual mold body 14 to the facial mold body 12.

In the illustrated embodiment, the restorative portion 17 is sized and shaped to mate with the anterior teeth of a patient. The engagement portions 19 are sized and shaped to be adjacent the posterior teeth. However, in other embodiments (not illustrated), an engagement portion 19 could be adjacent the anterior teeth and the restorative portion 17 mate with the posterior teeth.

The lingual mold body 14 includes a plurality of an engagement surfaces 43 adjacent the occlusal surfaces of the patient's teeth or located proximate to an incisal edge of a tooth or teeth to be restored. This arrangement is convenient for the clip 44 to snap under the occlusal surfaces or incisal edge of the patient's teeth, spaced away from their tongue. However, in other embodiments not illustrated, the engagement surface 43 may instead be adjacent the gingiva of the patient's teeth, with the clip 44 likewise being in a similar position.

The lingual body 14 includes mold surfaces 64 sized to create appropriate mold cavity or cavities with the inner surface 42 of the door (not shown) and/or in combination with the tooth structure of a patient to help shape the restorative material that is placed in the mold cavity or cavities in order to define the surface of the tooth or teeth to be restored.

The lingual mold body 14 may include a custom lingual rib 39 to provide additional clamping or mating to the individual patient's mouth.

The lingual mold body 14 may include a second alignment member 54 sized and shaped to fit with the first alignment member 52. In the illustrated embodiment, the second alignment member 54 may be mesial alignment receptor. Specifically, the second alignment member may be a slot 55 sized to receive the post 52 on the facial mold body 12.

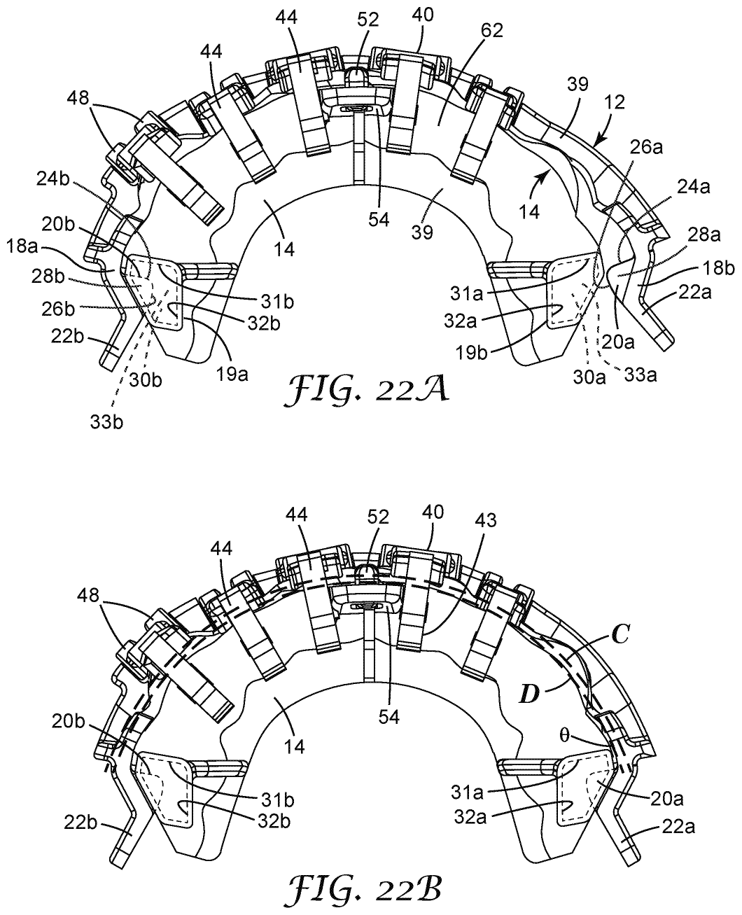

FIGS. 22A, 22B and 23 are useful for illustrating how the facial mold body 12 and lingual mold body 14 are assembled together and around the teeth of a patient to form a custom tool 10. One of the major benefits of this design is that once assembled, movement between the facial mold body and the lingual mold body is restricted in multiple directions and multiple rotations. Further, the spring action of the clamping members serve to provide an active seating force to drive the facial and lingual matrix into position on the teeth. As a result, practitioners are able to create more accurate restorations for their patients.

With FIGS. 22A and 22B as a point of reference, a practitioner may first place the lingual mold body 14 behind the patient's teeth, with the second alignment member 54 centered adjacent the occlusal surfaces of the patient's teeth. Then, the practitioner may place the facial mold body 12 over the front of the teeth and align the first alignment member 52, the post, to fit into the second alignment member 54, the hole. However, in other embodiments, mold bodies 12, 14 could include indicia or alignment features (e.g., visual indicators, other forms of mechanical mating features, keyholes, notches, and the like) to help a practitioner properly align and easily engage facial mold body 12 and lingual mold body 14 with one another.

The facial and lingual mold bodies 12, 14 are preferably made of flexible elastic materials to bend them at certain radiuses to successfully interlock them together, as illustrated in FIGS. 22A and 22B. A practitioner will interlock the mold bodies 12, 14 together by placing the protrusions 20a, 20b into the corresponding indentations 30a. 30b. The release tabs 22a, 22b may optionally be used to help fit protrusions 20a, 20b into the indentations 30a, 30b. Custom tools can be made from the full range of 3D printed materials, molded polymeric material or CAD/CAM shaped polymeric materials having certain desired strength, flexibility, translucency, or color. For example, the mold material can be polymeric material that may be transparent, translucent, or opaque. In some embodiments, clear or substantially transparent polymeric material that may include, for example, one or more of amorphous thermoplastic polymers, semi-crystalline thermoplastic polymers, transparent thermoplastic polymers, and thermoset polymers. Thermoplastics can be chosen from polycarbonate, thermoplastic acrylic, polyurethane, polysulfone, polyprolylene, polypropylene/ethylene copolymer, cyclic olefin polymer/copolymer, poly-4-methyl-1-pentene or polyester/polycarbonate copolymer, styrenic polymeric materials, polyamide, polymethylpentene, polyetheretherketone and combinations thereof. In another embodiment, the mold may be chosen from clear or substantially transparent semi-crystalline thermoplastic, crystalline thermoplastics and composites, such as polyamide, polyethylene terephthalate, polybutylene terephthalate, polyester/polycarbonate copolymer, polyolefin, cyclic olefin polymer, styrenic copolymer, polyetherimide, polyetheretherketone, polyethersulfone, polytrimethylene terephthalate, and mixtures and combinations thereof. In some embodiments, the mold is a polymeric material chosen from polyethylene terephthalate, polyethylene terephthalate glycol, poly cyclohexylenedimethylene terephthalate glycol, and mixtures and combinations thereof. In additional embodiments thermoset polymers include acrylics, urethanes, esters, silicones, thiolenes, epoxies, olefin metathesis and combinations thereof.

The custom tool 10 is designed to ensure a relatively tight fit between the mold bodies 12, 14 to assure an accurate and precisely shaped restoration while helping reduce or eliminate the flash that occurs along the edge where to the two mate together. Any flash that does occur may be very thin along the incisal edge and may be easily removed with a dental instrument. By providing a relatively tight fit along the incisal edge or another edge of mold bodies 12,14, this may help excess restorative material preferentially flow toward vent 50 where flash may be relatively easily seen and removed during finishing of the restoration.

FIG. 22B is convenient for describing the clamping force that can be generated between the facial mold body 12 and the lingual mold body 14. The facial mold body 12 has a certain arch length (C, and the lingual mold body 14 has a certain arch length (D). When the custom tool 10 is made, the geometry of the facial and/or lingual mold bodies 12, 14 is altered. For instance, the arch length C of the facial mold body 12 may be shortened, while the arch length D of the lingual mold body is maintained, and this configuration creates a clamping force between the two mold bodes 12, 14 when they are assembled. In addition, the mold bodies 12, 14 are sufficiently strong so as not to break or buckle, and the protrusion 20 and the indentation 30 can be interlocked without creating undue pressure in the mouth of the patient. Clamping forces can also be generated by slightly reducing the radius of curvature of the facial mold body 12, while maintaining the radius of curvature of the lingual mold body 14. Angle θ illustrates the latching surface relative to the arch tangent.

The degree of clamping force between the facial mold body 12 and the lingual mold body 14 should be tailored to balance the security of the installed tool 10 around the patient's teeth and sealing it against the teeth and interproximal features of the labial and lingual mold with ease of installation into and removal from the patient's mouth. The degree of clamping force can be increased by increasing the stiffness of the mold bodies 12, 14 via materials, geometry the amount of shortening of the facial mold body 12, and/or reduction of the radius of curvature of the facial mold body 12. Modifications to the mold bodies 12, 14 can be applied across the mold bodies, for instance by applying an appropriate shrinkage factor, or they can be applied locally to various regions of the mold bodies and/or latching mechanism between the two. Latch securement and case of engagement and removal can be tailored by adjusting the latching angle, length of the latching surfaces (engagement surface) 31 32, 33 and topography of the surfaces 24, 26, 28 to obtain the best balance of performance. Tools such as finite element modeling can be used to predict the appropriate parameters for a given custom tool based on test results of previously tested cases. Machine learning can be applied to improve prediction capability over time, including feedback on clinical performance from practitioners. Digital design and manufacturing, such as 3D printing or CNC machining, is particularly helpful in creating custom tool molds with active clamping forces.

In some examples, the tool 10 may include injection ports 226 to allow the practitioner to apply the restorative material 111 directly to the tooth to be restored. However, in other examples, the practitioner may apply the restorative material 111 to the tooth to be restored or to mold body 12, 14 before applying mold bodies 12, 14 over the teeth 72 of the patient.

The practitioner may fill the mold cavity defined by mold bodies 12, 14 and the teeth around which the mold bodies 12, 14 are positioned with restorative material 111 by introducing the restorative material 111 through one or more of apertures 34 illustrated in FIG. 21 and into the mold cavity. In some examples, the practitioner may use various tools to place the restorative material into the mold cavity. In some examples, restorative material 111 may be placed in the mold cavity through multiple apertures. One preferable dental restorative material is 3M™ Filtek™ Supreme Ultra Universal Restorative, commercially available from 3M Company based in St. Paul. Minnesota. In some examples the composite material is warmed to tailor the viscosity prior to use. In other examples a flowable such as 3M™ Filtek™ Supreme Flowable Restorative is placed into the cavity prior to placement of a universal composite to optimize adaptation of the composite onto the teeth. After at least some restorative material 111 is introduced into the mold cavity, the practitioner may then close the door bodies 40 within the corresponding apertures 34 (FIG. 21-23). The inner surfaces 42 of door bodies 40 and the mold surfaces 64 may be used to shape one or more layers of restorative material 111 on the facial or lingual surface of the tooth 72, to compress restorative material 111 within the mold cavity, or any combination thereof.

In some examples, the practitioner may cure the restorative material 111, while the door bodies 40 are closed into the apertures 34 of the facial mold body 12. For example, if the restorative material is light curable, the practitioner may expose the restorative material to the curing light (e.g., a blue light) through one or both of the mold bodies 12, 14, which may be formed of a material transparent to the curing light. The practitioner may remove the facial mold body 12 and the lingual mold body 14 from the teeth, which now have restored structure defined by the restorative material. Removing the mold bodies 12, 14 from the mouth may include separating the facial mold body 12 from the lingual mold body 14, which may include, for example, disengaging one or more of the first engagement portions 18a, 19a of the mold bodies 12, 14 from the second engagement portions 19a, 19b of the mold bodies 12, 14. In some example, the one or more of the door bodies 40 may leave “witness marks” on the lingual or facial surface of the tooth, but such marks may be relatively easily removable because they are relatively thin. In some examples, the practitioner may finish the teeth, which now include restored dental structure defined by the restorative material, such as by polishing, to remove flash or other undesired surface imperfections.

In some examples, the practitioner may place a release film on at least a portion of a surface 42 of the door 40 before placing the door 40 within its respective aperture 34. The release film may reduce the likelihood of trapping air within the mold cavity during stamping of the restorative material 80 with the door and/or may facilitate release of restorative material 40 from the surface 42 of the door 40.

In addition to, or instead of, the release film, in some examples, the device manufacturer or practitioner may apply a coating on at least a portion of a surface 42 of the door 40 and/or the door body before placing the door 40 within the respective aperture 34. The coating may reduce the likelihood of trapping air within the mold cavity during stamping of the restorative material with the door and/or may facilitate release of restorative material from the surface of the door. Release coatings may also be applied to any of the mold components during the manufacturing process. Release coatings and films may also assist by allowing opening of the doors for inspection periodically during the process to assure that a complete fill with minimal flash is obtained prior to curing.

The introduction of the restorative material 111 into mold cavity may have enough force to separate parts of mold bodies 12, 14 from each other, thereby providing less of an engagement between facial mold body 12 and lingual mold body 14 and/or less of a customized fit with one or more teeth. However, the engagement portions 18, 19 help mold bodies 12, 14 self-align with each other and stay firmly fixed relatively to each other.

In the example shown in FIG. 21-23, the facial body 12 includes one or more apertures 34, which may each be configured to align with a portion of a facial surface of a respective tooth of the patient to be restored. In some examples, the portion is a majority of the facial surface of the tooth to be restored. The surface of the teeth to be restored and aligned with the respective apertures 34 may, for example, be defined by existing teeth structure or by the dental restoration formed using the facial mold body 12 and lingual mold body 14.

In the illustrated embodiment, there are two engagement portions 18a, 18b positioned at opposite ends of the restorative portion 16, which is located between the engagement portions 18a, 18b. This is ideal, but necessary. For example, the facial mold body 12 could include just one engagement portion 18 positioned adjacent the restorative portion 16. In tools having two engagement portions 18a, 18b, this provides two points of interlock between the lingual and facial mold bodies 12, 14.

The first engagement portion 18a and second engagement portion 18b both extend away from the restorative portion. In the illustrated embodiment, the engagement portions 18 extend at a generally right angle relative to the restorative portion 16. When compared to the patient's mouth, which includes an occlusal plane shown generally by line X-X (in FIG. 6B) the engagement portions 18 extend generally perpendicular to such occlusal plane.

The length of the engagement portions 18 extend some distance from the restorative portion 16 of the facial mold body 12. The length of the engagement portions may be customized and optimized for the individual patient. If the engagement portions are too long, they will stretch the patient's jaw, making it uncomfortable or painful for the patient. If the engagement portions are too short, the facial mold body 12 will disengage from the patient's teeth. In one embodiment, the length of the engagement portions may be 1 mm to 5 cm in length. However, it may depend on where exactly the engagement portions are located in the patient's mouth. They may be longer, if they are attached to the patient's teeth near the front of the mouth, such as the incisors. They may be shorter, if they are attached to the back of the mouth, like the molars. Also, the patient's overall opening distance between the upper and lower arches of teeth is a consideration.

In the illustrated embodiment, the restorative mold body 16 is sized and shaped to mate with the anterior teeth of a patient. The engagement portions 18 are sized and shaped be adjacent to the posterior teeth. However, in other embodiments (not illustrated), an engagement portion 18 could be adjacent the anterior teeth and the restorative portions 16 could be adjacent the posterior teeth.

In the example shown in the Figures, the facial body 12 includes one or more apertures 34, which may each be configured to align with a portion of a facial surface of a respective tooth of the patient to be restored. In some examples, the portion is a majority of the facial surface of the tooth to be restored. For example, aperture 34a may be configured to align with a portion comprising a majority of a facial surface of one tooth and aperture 34b may be configured to align with a portion comprising a majority of a facial surface of another tooth. The surface of the tooth to be restored and aligned with the respective apertures 34 may, for example, be defined by existing tooth structure or by the dental restoration formed using the facial mold body 12 and lingual mold body 14.

Each of the apertures 34 has a suitable configuration (e.g., shape and/or size) for introducing restorative material into a mold cavity defined by an interior surface 42 of door 40 and the interior mold surface 64 to cover the portion of the surface of the tooth to be restored, where both interior surfaces 42, 64 are surfaces facing the tooth or teeth to be restored. When door 40 is mated with a respective aperture 34, the surface 42 of the door 40 and the tooth structure of a patient may help shape the restorative material that is placed in the mold cavity. e.g., in order to define the surface of the tooth to be restored.

In some embodiments, the shape of one or more of apertures 34 may be designed to substantially match the shape of the tooth and/or the portion of the tooth to be restored. For example, apertures 34 may be substantially noncircular. In other examples, however, the shape of one or more apertures 34 may be circular.

Apertures 34 may be sized to be larger than a tip of a dental capsule or a syringe tip that is used to introduce restorative dental material 111 into the mold cavity defined by mold bodies 12, 14. Apertures 34 may be sufficiently large to allow placement and flow of restorative material to cover the portion of the surface of the tooth being restored. Additionally, or alternatively, apertures 34 may be sufficiently large to allow movement of the tip of the capsule or syringe tip within aperture 34. In other examples the apertures may closely match the size of the tip used to place the composite via an injection technique.

The facial mold body 12 may have individual doors 40 sized to closely fit with corresponding apertures 34. In some examples, door body 40 may be physically separate from (unconnected to) mold body 12. In these examples, a practitioner may freely move door body 40 relative to apertures 34b and place door body 40 in the respective aperture 34 by bringing door body 40 into alignment with aperture 34 from any suitable angle. In other examples, however, door body 40 and mold body 12 are mechanically connected to each other, such as by using a hinge. For example, door body 40 and mold body 10 may be connected via a snap hinge, a living hinge, a barrel hinge, a pin joint hinge, or any other suitable type of hinge. An example of a hinge connection between a door body and a mold body is described with reference to FIGS. 21-23 4B.

Each door 40 may be attached to the facial mold body 12 as illustrated with a hinge 48 and hinge pin 46 at one end, and an attachment mechanism 44 at the other end. The attachment mechanism 44 in this case is a clip 44 which is designed to clip over or snap onto an engagement surface 43 on the lingual mold body 14. As such, the hinge 48 and hinge pin 46 are adjacent the gingiva of the patient's teeth and the clip 44 and engagement surface 43 are adjacent the occlusal surfaces of the patient's teeth or located proximate an incisal edge of a tooth or teeth to be restored. This arrangement is convenient for the clip to snap under the occlusal surfaces or incisal edge of the patient's teeth, spaced away from their tongue. However, in other embodiments not illustrated, their relative positions may be reversed, with the clip 44 and engagement surface 43 adjacent the gingiva of the patient's teeth and hinge 48 and hinge pin 46 adjacent the incisal or occlusal surfaces of the patient's teeth.

In the illustrated embodiment, the door body 40 and facial mold body 12 are mechanically connected to each other by using a hinge 48 and hinge pin. This configuration helps maintain proper alignment between the door body 40 and corresponding aperture 34 during use of custom tool 10. However, door body 40 and facial mold body 12 may be connected via a snap hinge, a living hinge, a barrel hinge, a pin joint hinge, or any other suitable type of hinge. Door hinge 48 and hinge pin 46 may be formed separate from the door body 40 and/or facial mold body 12, or door hinge 48 and hinge pin 46 may be formed as an integral part of door body 40 and/or facial mold body 12.

The facial mold body 12 may include a first alignment member 52, which assists in properly aligning the facial and lingual mold bodies 12, 14 before interlocking them together. In the illustrated embodiment, the first alignment member 52 is a post that is sized to fit with the second alignment member 54 in the lingual mold body 14, shown as a slot 55 in FIGS. 21-23.

Custom tools as described herein may be formed based on a digital model of the teeth and mouth of an individual patient, which can be produced from an intra-oral 3D scan, such as an intraoral scanner. In one particular example, the custom tools may be digitally designed using CAD software, such as solid modeling software based on the digital model of the planned restored dentition. Custom tool was designed to fit over the tooth or teeth to be restored teeth (the restorative portion) and a portion of the neighboring teeth (the engagement portions). Subsequently, the tooth structure model of the restored teeth may be digitally subtracted from a mold block to create a tool. Alternatively, an inverse of the tooth structure may be inverted within software to define the mold block. Engagement portions may be located in regions which correspond to regions of the teeth where they will extend from. The performance of digital designs on the model of restored dentition, extends as well to all of the interproximal features described in this application. For instance, although depicted as generally planar features, the interproximal features may be blended to the dentition scan data, the planar features can be selectively thickened (e.g. ramped) to provide additional stiffness and stability while assuring maximum penetration into interproximal space. The features also may be warped, to accommodate specific features in the dentition, such as abnormally shaped teeth and embrasures.

Within the digital model, the mold block design may be segmented into two sections (facial mold body and lingual mold body) to facilitate eventual assembly of the tool components on the teeth, with specific geometric interferences selected related to the arch lengths to provide desired the clamping forces, as discussed above. Within the digital model, engagement portions with certain interlocking geometries are designed, selecting overall heights of the engagement portions based where the engagement portions are placed within the patient's mouth, as discussed in more detail above.

In one particular example, custom tool 10 may be digitally designed using CAD software, such as solid modeling software based on the digital model. For example, fixed, parametric, or libraries of tool blank forms may be created in CAD software (e.g. Solidworks, NX/Unigraphics, ProEngineer, etc.). These objects are typically exported into a separate 3D virtual work environment capable of managing point cloud or triangular mesh data and capable to performing Boolean operations (e.g. Materialise Magics, SpaceClaim). Optionally, the standard forms are scaled to assure a proper fit between the standard part and the patients' dentition. The patient data may then be subtracted from the standard form. As an alternative approach to Boolean subtraction, the tool design may be cut from a virtual shell built onto the target tooth structure.

One preferred embodiment of software suitable for the making the custom molds having interproximal portions described herein is U.S. Patent Application Ser. No. 63/260,717, filed Aug. 30, 2021 (Attorney Docket Number 83805US002), titled “Digital Design of Dental Matrix with Improved Customized Interproximal Contacts,” which is hereby incorporated by reference

Another embodiment of the custom tool 10 includes choosing a first interproximal portion of a mold body based on a scanned three-dimensional image of the tooth of the patient and choosing a second interproximal portion of the mold body based on an interproximal surface of a tooth selected or synthesized from geometric data not affiliated with the patient. For instance, the geometric data could include anatomical averages and algorithms, or different sets of geometrical rules or algorithms. Or the geometric data could include digitally stored images in a library of images. Lastly, the second interproximal portion could be selected from an existing contact from a patient scan, a contact in a digital wax up, a contact below to lengthen the contact in a wax up, a contact based on dentist's preference, or an open contact.

### EXEMPLARY EMBODIMENTS

Embodiment 1 is a custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of the tooth and a second interproximal portion corresponding with the second interproximal surface of the tooth; and a second mold body providing for a customized fit with the at least one tooth of the patient, wherein the second mold body includes a portion corresponding with a second surface of the tooth, and a first interproximal portion corresponding with a first interproximal surface of the tooth and a second interproximal portion corresponding with the second interproximal surface of the tooth, wherein the first interproximal portion of the first mold body and the first interproximal portion of the second mold body each have a patient-specific customized fit and wherein the second interproximal portion of the first mold body and the second interproximal portion of the second mold body each have a patient-specific customized fit, wherein the first mold body and second mold body are configured to combine with the tooth of the patient to form a mold cavity encompassing a portion of missing tooth structure of the tooth, and wherein a first portion of the missing tooth structure includes missing interproximal tooth structure.

Embodiment 2 is the custom tool of Embodiment 1, wherein the first mold body and second mold body are two separate portions which combine together in the mouth of the patient.

Embodiment 3 is the custom tool of Embodiment 2, wherein the custom tool further includes a hinge portion to connecting the first mold body and the second mold body.

Embodiment 4 is the custom tool of Embodiments 2-3, wherein the first mold body and second mold body form a one-piece, monolithic, integrally formed mold body.

Embodiment 5 is the custom tool of Embodiments 2-4, wherein the first interproximal portion of the first mold body and the first interproximal portion of the second mold body are designed to fit together to provide a selected interproximal tooth structure and wherein the second interproximal portion of the first mold body and the second interproximal portion of the second mold body are each designed to fit together to provide a selected interproximal tooth structure.

Embodiment 6 is the custom tool of Embodiment 5, wherein the selected interproximal tooth structure is chosen to allow dental floss to pass through between adjacent teeth.

Embodiment 7 is the custom tool of Embodiments 5-6, wherein the selected interproximal tooth structure is chosen to allow a dentist to separate the interproximal tooth structure formed between adjacent teeth.

Embodiment 8 is the custom tool of Embodiments 1-7, wherein the first interproximal portion of the first mold body and the first interproximal portion of the second mold body are substantially aligned with one another along the occlusal-gingival axis.

Embodiment 9 is the custom tool of Embodiments 1-8, wherein the first interproximal portion of the first mold body and the first interproximal portion of the second mold body are substantially offset from one another along the occlusal-gingival axis.

Embodiment 10 is the custom tool of Embodiment 1-10, wherein the first interproximal portion of the first mold body includes a first thickness measured along the mesial-distal axis and the first interproximal portion of the second mold body includes a second thickness measured along the mesial-distal axis, and wherein the first thickness is approximately the same as the second thickness.

Embodiment 11 is the custom tool of Embodiment 1, wherein the first interproximal portion of the first mold body includes a first region and a second region along the occlusal-gingival axis.

Embodiment 12 is the custom tool of Embodiment 11, wherein the first region includes a first thickness measured along the mesial-distal axis and wherein the second region includes a second thickness measured along the occlusal-gingival axis, and wherein the first thickness is less than the second thickness.

Embodiment 13 is the custom tool of Embodiment 12, wherein the first interproximal portion of the second mold body includes a first region and a second region, wherein the first region includes a first thickness measured along the mesial-distal axis and wherein the second region includes a second thickness measured along the mesial-distal axis, and wherein the first thickness is less than the second thickness.

Embodiment 14 is the custom tool of Embodiments 12-13, wherein the first interproximal portion of the first mold body further includes third region along the occlusal-gingival axis, wherein the third region includes a third thickness measured along the mesial-distal axis, and wherein the second thickness is less than the third thickness.

Embodiment 15 is the custom tool of Embodiment 14, wherein the first region is an occlusal region, the second region is a middle region, and the third region is a gingival region.

Embodiment 16 is the custom tool of Embodiments 1-15, wherein the first interproximal of the first mold body has a first thickness measured along the mesial-distal axis, and the first interproximal of the second mold body has a second thickness measured along the mesial-distal axis, and the first thickness is less than the second thickness.

Embodiment 17 is the custom tool of Embodiment 16, wherein the second interproximal portion of the second mold body has a first thickness measured along the mesial-distal axis and the second interproximal portion of the second mold body has a second thickness measured along the mesial-distal axis and wherein the first thickness is less than the second thickness.

Embodiment 18 is the custom tool of Embodiments 1-17, wherein the first interproximal portion of the first mold body includes a first region, a second region, and a third region along the occlusal-gingival axis and wherein the first interproximal portion of the second mold body includes a first region, a second region, and a third region, and wherein the second region of the first interproximal portion of the first mold body includes a portion of an aperture and the second region of the first interproximal portion of the second mold body includes another portion of the aperture.

Embodiment 19 is the custom tool of Embodiment 18, wherein the second interproximal portion of the first mold body includes a first region, a second region and a third region along the occlusal-gingival axis and wherein the second interproximal portion of the second mold body includes a first region, a second region, and a third region along the occlusal-gingival axis, and wherein the second region of the second interproximal portion of the first mold body includes a portion of an aperture and the second region of the second interproximal portion of the second mold body includes another portion of the aperture.

Embodiment 20 is the custom tool of Embodiments 1-19, wherein the first interproximal portion of the first mold body includes a first region and a second region and wherein the first interproximal portion of the second mold body includes a first region and a second region, wherein the first regions of the first interproximal portion of both the first and second mold bodies includes a first depth measured along the facial-lingual axis, wherein the second regions of the first interproximal portion of both the first and second mold bodies includes a second depth measured along the facial-lingual axis, wherein the second depth is less than the first depth.

Embodiment 21 is the custom tool of Embodiment 20, wherein the second regions of the first interproximal portion of both the first and second mold bodies include a curved surface.

Embodiment 22 is the custom tool of Embodiment 21, wherein the first region of the first interproximal portion of both the first and second mold bodies have matched planar portions.

Embodiment 23 is the custom tool of Embodiments 1-22, wherein the first interproximal portion includes a length measured along a occlusal-gingival axis and a thickness measured along a mesial-distal axis, and wherein the length to thickness ratio >5.

Embodiment 24 is the custom tool of Embodiments 1-23, wherein the first interproximal portion includes a length measured along a occlusal-gingival axis and a depth measured along the facial-lingual axis, and wherein the length to depth ratio >5.

Embodiment 25 is the custom tool for forming a dental restoration in a mouth of a patient, the custom tool comprising: a first mold body providing for a customized fit with at least three teeth of the patient, wherein the first mold body includes a first portion corresponding with at least a first surface of a first tooth and a first interproximal portion corresponding with a first interproximal surface of the first tooth and a second interproximal portion corresponding with the second interproximal surface of the first tooth, wherein the first mold body includes a second portion corresponding with at least a first surface of a second tooth and a first interproximal portion corresponding with a first interproximal surface of the second tooth, wherein the first mold body includes a third portion corresponding with at least a first surface of a third tooth and a first interproximal portion corresponding with a first interproximal surface of the third tooth; and wherein the first interproximal portion and the second interproximal portion of the first mold body each have a patient-specific digitally engineered interproximal portion, wherein the first mold body is configured to combine with the three teeth of the patient to form a mold cavity encompassing a portion of missing tooth structure of the three teeth, and wherein a first portion of the missing tooth structure includes missing interproximal tooth structure of the first interproximal surface of the first tooth and the second interproximal surface of the first tooth.

Embodiment 26 is the custom tool of Embodiment 25, wherein the first mold body further includes a second interproximal portion corresponding with the second interproximal surface of the second tooth and a second interproximal portion corresponding with the second interproximal surface of the third tooth

Embodiment 27 is the custom tool of Embodiment 25, further comprising a second mold body providing for a customized fit with the at least three teeth of the patient, wherein the second mold body includes a first portion corresponding with a second surface of the first tooth, and a first interproximal portion corresponding with a first interproximal surface of the first tooth and a second interproximal portion corresponding with the second interproximal surface of the first tooth, wherein the second mold body includes a second portion corresponding with a first surface of a second tooth and a first interproximal portion corresponding with a first interproximal surface of the second tooth and a second interproximal portion corresponding with the second interproximal surface of the second tooth, wherein the second mold body includes a third portion corresponding with at least a first surface of a third tooth and a first interproximal portion corresponding with a first interproximal surface of the third tooth and a second interproximal portion corresponding with the second interproximal surface of the third tooth: wherein the first interproximal portion of the first mold body and the first interproximal portion of the second mold body each have a patient-specific customized fit and wherein the second interproximal portion of the first mold body and the second interproximal portion of the second mold body each have a patient-specific customized fit, wherein the first mold body and second mold body are configured to combine with the three teeth of the patient to form a mold cavity encompassing a portion of missing tooth structure of the three teeth, and wherein a first portion of the missing tooth structure includes missing interproximal tooth structure of the first interproximal surface of the first tooth and the second interproximal surface of the first tooth.

Embodiment 28 is the custom tool of Embodiment 27, wherein the first mold body and second mold body are two separate portions which combine together in the mouth of the patient.

Embodiment 29 is the custom tool of Embodiment 28, wherein the custom tool further includes a hinge portion to connecting the first mold body and the second mold body.

Embodiment 30 is the custom tool of Embodiment 27, wherein the first mold body and second mold body form a one-piece, monolithic, integrally formed mold body.

Embodiment 31 is the custom tool of Embodiment 27, wherein the first interproximal portion of the first mold body and the first interproximal portion of the second mold body are designed to fit together to provide a selected interproximal tooth structure and wherein the second interproximal portion of the first mold body and the second interproximal portion of the second mold body are each designed to fit together to provide a selected interproximal tooth structure.

Embodiment 32 is the custom tool of Embodiment 31, wherein the selected interproximal tooth structure is chosen to allow dental floss to pass through between adjacent teeth.

Embodiment 33 is the custom tool of Embodiment 32, wherein the selected interproximal tooth structure is chosen to allow a dentist to separate the interproximal tooth structure formed between adjacent teeth.

Embodiment 34 is the custom tool of Embodiments 27-33, wherein the first interproximal portion of the first mold body and the first interproximal portion of the second mold body are substantially aligned with one another along the occlusal-gingival axis.

Embodiment 35 is the custom tool of Embodiments 27-34, wherein the first interproximal portion of the first mold body and the first interproximal portion of the second mold body are substantially offset from one another along the occlusal-gingival axis.

Embodiment 36 is the custom tool of Embodiment 35, wherein the first interproximal portion of the first mold body includes a first thickness measured along the mesial-distal axis and the first interproximal portion of the second mold body includes a second thickness measured along the mesial-distal axis, and wherein the first thickness is approximately the same as the second thickness.

Embodiment 37 is the custom tool of Embodiments 25-36, wherein the first interproximal portion of the first mold body includes a first region and a second region along the occlusal-gingival axis.

Embodiment 38 is the custom tool of Embodiment 37, wherein the first region includes a first thickness measured along the mesial-distal axis and wherein the second region includes a second thickness measured along the occlusal-gingival axis, and wherein the first thickness is less than the second thickness.

Embodiment 39 is the custom tool of Embodiment 38, wherein the first interproximal portion of the second mold body includes a first region and a second region, wherein the first region includes a first thickness measured along the mesial-distal axis and wherein the second region includes a second thickness measured along the mesial-distal axis, and wherein the first thickness is less than the second thickness.

Embodiment 40 is the custom tool of Embodiment 38, wherein the first interproximal portion of the first mold body further includes third region along the occlusal-gingival axis, wherein the third region includes a third thickness measured along the mesial-distal axis, and wherein the second thickness is less than the third thickness.

Embodiment 41 is the custom tool of Embodiment 40, wherein the first region is an occlusal region, the second region is a middle region, and the third region is a gingival region.

Embodiment 42 is the custom tool of Embodiments 27-41, wherein the first interproximal of the first mold body has a first thickness measured along the mesial-distal axis, and the first interproximal of the second mold body has a second thickness measured along the mesial-distal axis, and the first thickness is less than the second thickness.

Embodiment 43 is the custom tool of Embodiment 42, wherein the second interproximal portion of the second mold body has a first thickness measured along the mesial-distal axis and the second interproximal portion of the second mold body has a second thickness measured along the mesial-distal axis and wherein the first thickness is less than the second thickness.

Embodiment 44 is the custom tool of Embodiments 25-42, wherein the first interproximal portion of the first mold body includes a first region, a second region, and a third region along the occlusal-gingival axis and wherein the first interproximal portion of the second mold body includes a first region, a second region, and a third region, and wherein the second region of the first interproximal portion of the first mold body includes a portion of an aperture and the second region of the first interproximal portion of the second mold body includes another portion of the aperture,

Embodiment 45 is the custom tool of Embodiment 44, wherein the second interproximal portion of the first mold body includes a first region, a second region and a third region along the occlusal-gingival axis and wherein the second interproximal portion of the second mold body includes a first region, a second region, and a third region along the occlusal-gingival axis, wherein the second thickness includes a portion of another aperture.

Embodiment 46 is the custom tool of Embodiment 25-45, wherein the first interproximal portion of the first mold body includes a first region and a second region and wherein the first interproximal portion of the second mold body includes a first region and a second region, wherein the first regions of the first interproximal portion of both the first and second mold bodies includes a first depth measured along the facial-lingual axis, wherein the second regions of the first interproximal portion of both the first and second mold bodies includes a second depth measured along the facial-lingual axis, wherein the second depth is less than the first depth.

Embodiment 47 is the custom tool of Embodiment 46, wherein the second regions of the first interproximal portion of both the first and second mold bodies include a curved surface.

Embodiment 48 is the custom tool of Embodiment 47, wherein the first region of the first interproximal portion of both the first and second mold bodies have matched planar portions.

Embodiment 49 is the custom tool of Embodiments 25-48, wherein the first interproximal portion includes a length measured along a occlusal-gingival axis and a thickness measured along a mesial-distal axis, and wherein the length to thickness ratio >5.

Embodiment 50 is the custom tool of Embodiments 25-49, wherein the first interproximal portion includes a length measured along a occlusal-gingival axis and a depth measured along the facial-lingual axis, and wherein the length to depth ratio >5.

Embodiment 51 is a custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of the tooth and a second interproximal portion corresponding with the second interproximal surface of the tooth; and a second mold body providing for a customized fit with the at least one tooth of the patient, wherein the second mold body includes a portion corresponding with a second surface of the tooth, and a first interproximal portion corresponding with a first interproximal surface of the tooth and a second interproximal portion corresponding with the second interproximal surface of the tooth, wherein the first interproximal portion of the first mold body includes a first region and a second region along the occlusal-gingival axis and wherein the first interproximal portion of the second mold body includes a first region and a second region along the occlusal-gingival axis and wherein the first region of the first interproximal portion of the first mold body is designed to correspond with the first region of the first interproximal portion of the second mold body; and wherein the second region of the first interproximal portion of the first mold body is designed to correspond with the first region of the first interproximal portion of the second mold body.

Embodiment 52 is the custom tool of Embodiment 51, wherein the first region of the first interproximal portion of the first mold body is designed to mate with the first region of the first interproximal portion of the second mold body; and wherein the second region of the first interproximal portion of the first mold body is designed to mate with the first region of the first interproximal portion of the second mold body.

Embodiment 53 is the custom tool of Embodiment 51, wherein the first interproximal portion of the first mold body further includes a third region along the occlusal-gingival axis and wherein the second interproximal portion of the first mold body includes a third region along the occlusal-gingival axis: wherein the first interproximal portion of the second mold body includes a third region along the occlusal-gingival axis: wherein the second interproximal portion of the second mold body includes a third region along the occlusal-gingival axis: wherein the third region of the first interproximal portion of the first mold body is designed to correspond with the third region of the first interproximal portion of the second mold body.

Embodiment 54 is the custom tool of Embodiment 53, wherein the third region of the first interproximal portion of the first mold body is designed to mate with the third region of the first interproximal portion of the second mold body.

Embodiment 55 is the custom tool of Embodiment 53, wherein the first regions of the first interproximal portion of both the first and second mold bodies includes a first thickness measured along the mesial-distal axis, wherein the second regions of the first interproximal portion of both the first and second mold bodies includes a second thickness measured along the mesial-distal axis, wherein the third regions of the first interproximal portions of both the first and second mold bodies includes a third thickness measured along the mesial-distal axis, wherein the second thickness is less than the first thickness and less than the third thickness.

Embodiment 56 is the custom tool of Embodiment 55, wherein the first interproximal portion of the first mold body includes a first region, a second region and a third region along the occlusal-gingival axis and wherein the first interproximal portion of the second mold body includes a first region, a second region, and a third region along the occlusal-gingival axis, and wherein the second region of the first interproximal portion of the first mold body includes a portion of an aperture and the second region of the first interproximal portion of the second mold body includes another portion of the aperture.

Embodiment 57 is the custom tool of Embodiments 51-56, wherein the first region of the first interproximal portion includes a first thickness measured along the mesial-distal-gingival axis and wherein the second region of the first interproximal portion includes a second thickness measured along the mesial-distal axis, and wherein the first thickness is less than the second thickness.

Embodiment 58 is the custom tool of Embodiments 51-57, wherein the second interproximal portion of the first mold body includes a first region and a second region along the occlusal-gingival axis, wherein the first region includes a first thickness measured along the mesial-distal axis and wherein the second region includes a second thickness measured along the mesial-distal axis, and wherein the first thickness is less than the second thickness.

Embodiment 59 is the custom tool of Embodiment 51-58, wherein the first interproximal portion of the first mold body includes a first region and a second region and wherein the first interproximal portion of the second mold body includes a first region and a second region, wherein the first regions of the first interproximal portion of both the first and second mold bodies includes a first depth measured along the facial-lingual axis, wherein the second regions of the first interproximal portion of both the first and second mold bodies includes a second depth measured along the facial-lingual axis, wherein the second depth is less than the first depth.

Embodiment 60 is the custom tool of Embodiment 59, wherein the second regions of the first interproximal portion of both the first and second mold bodies include a curved surface.

Embodiment 61 is the custom tool of Embodiment 60, wherein the first region of the first interproximal portion of both the first and second mold bodies have matched planar portions.

Embodiment 62 is the custom tool of Embodiment 61, wherein the first interproximal portion includes a length measured along a occlusal-gingival axis and a thickness measured along a mesial-distal axis, and wherein the length to thickness ratio >5.

Embodiment 63 is the custom tool of Embodiments 51-62, wherein the first interproximal portion includes a length measured along a occlusal-gingival axis and a depth measured along the facial-lingual axis, and wherein the length to depth ratio >5.

Embodiment 64 is the custom tool of Embodiments 51-63, wherein the first mold body and second mold body are two separate portions which combine together in the mouth of the patient.

Embodiment 65 is the custom tool of Embodiment 64, wherein the custom tool further includes a hinge portion to connecting the first mold body and the second mold body.

Embodiment 66. The custom tool of Embodiments 51-65, wherein the first mold body and second mold body form a one-piece, monolithic, integrally formed mold body.

Embodiment 67 is the custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of the tooth: a second mold body providing for a customized fit with the at least one tooth of the patient, wherein the second mold body includes a portion corresponding with a second surface of the tooth, and a first interproximal portion corresponding with a first interproximal surface of the tooth: wherein the first interproximal portion of the first mold body and the first interproximal portion of the second mold body are substantially offset from one another along the occlusal-gingival axis.

Embodiment 68 is the custom tool of Embodiment 67, wherein the first interproximal portion of the first mold body includes a first thickness measured along the mesial-distal axis and the first interproximal portion of the second mold body includes a second thickness measured along the mesial-distal axis, and wherein the first thickness is approximately the same as the second thickness.

Embodiment 69 is the custom tool of Embodiment 67, wherein the first mold body and second mold body are two separate portions which combine together in the mouth of the patient.

Embodiment 70 is the custom tool of Embodiment 69, wherein the custom tool further includes a hinge portion to connecting the first mold body and the second mold body.

Embodiment 71 is the custom tool of Embodiments 67-70, wherein the first mold body and second mold body form a one-piece, monolithic, integrally formed mold body.

Embodiment 72 is the custom tool of Embodiments 67-71, wherein the first interproximal portion includes a length measured along a occlusal-gingival axis and a thickness measured along a mesial-distal axis, and wherein the length to thickness ratio >5.

Embodiment 73 is the custom tool of Embodiments 67-72, wherein the first interproximal portion includes a length measured along a occlusal-gingival axis and a depth measured along the facial-lingual axis, and wherein the length to depth ratio >5.

Embodiment 74 is the custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of the tooth, wherein the first interproximal portion of the first mold body includes a first region and a second region along the occlusal-gingival axis, and wherein the first region has a first thickness measured along the mesial-distal axis and second region has a second thickness measured along the mesial-distal axis and wherein the first thickness is different than the second thickness.

Embodiment 75 is the custom tool of Embodiment 74, wherein the first thickness is less than the second thickness.

Embodiment 76 is the custom tool of Embodiment 74 further including a second mold body providing for a customized fit with at least one tooth of the patient, wherein the second mold body includes a portion corresponding with at least a first surface of the tooth and a first interproximal portion corresponding with a first interproximal surface of the tooth, wherein the first interproximal portion of the second mold body includes a first region and a second region along the occlusal-gingival axis, and wherein the first region has a first thickness measured along the mesial-distal axis and second region has a second thickness measured along the mesial-distal axis and wherein the first thickness is different than the second thickness.

Embodiment 77 is the custom tool of Embodiment 76, wherein the first thickness is less than the second thickness.

Embodiment 78 is the custom tool of Embodiments 76-77, wherein the first interproximal portion of the first mold body and the first interproximal portion of the second mold body are aligned with one another along the occlusal-gingival axis.

Embodiment 79 is the custom tool of Embodiments 76-78, wherein the first interproximal portion of the first mold body includes a third region along the occlusal-gingival axis and wherein the first interproximal portion of the second mold body includes a third region along the occlusal-gingival axis, wherein the first regions of the first interproximal portion of both the first and second mold bodies includes a first thickness measured along the mesial-distal axis, wherein the second regions of the first interproximal portion of both the first and second mold bodies includes a first thickness measured along the mesial-distal axis, wherein the third regions of the first interproximal portions of both the first and second mold bodies includes a third thickness measured along the mesial-distal axis, wherein the first thickness is less than the second thickness, and the second thickness is less than the third thickness.

Embodiment 80 is the custom tool of Embodiment 79, wherein the second interproximal portion of the first mold body includes a third region and wherein the second interproximal portion of the second mold body includes a third region, wherein the first regions of the second interproximal portion of both the first and second mold bodies includes a first thickness measured along the mesial distal axis, wherein the second regions of the second interproximal portion of both the first and second mold bodies includes a second thickness measured along the mesial-distal axis, wherein the third regions of the second interproximal portions of both the first and second mold bodies includes a third thickness measured along the mesial-distal axis, wherein the first thickness is less than the second thickness, and the second thickness is less than the third thickness.

Embodiment 81 is the custom tool of Embodiments 74-80, wherein the first interproximal portion includes a length measured along a occlusal-gingival axis and a thickness measured along a mesial-distal axis, and wherein the length to thickness ratio >5.

Embodiment 82 is the custom tool of Embodiments 74-81, wherein the first interproximal portion includes a length measured along a occlusal-gingival axis and a depth measured along the facial-lingual axis, and wherein the length to depth ratio >5.

Embodiment 83 is the custom tool of Embodiments 76-82, wherein the first mold body and second mold body are two separate portions which combine together in the mouth of the patient.

Embodiment 84 is the custom tool of Embodiment 83, wherein the custom tool further includes a hinge portion to connecting the first mold body and the second mold body.

Embodiment 85 is the custom tool of Embodiments 75-84, wherein the first mold body and second mold body form a one-piece, monolithic, integrally formed mold body.

Embodiment 86 is the custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of the tooth, a second mold body providing for a customized fit with at least one tooth of the patient, wherein the first mold body includes a portion corresponding with at least a second surface of the tooth and a first interproximal portion corresponding with a first interproximal surface of the tooth, wherein the first interproximal portion of the first mold body has a first thickness measured along a mesial-distal axis and the first interproximal portion of the second mold body has a second thickness measured along a mesial-distal axis, and wherein the first thickness is different than the second thickness.

Embodiment 87 is the custom tool of Embodiment 86, wherein the first thickness is less than the second thickness.

Embodiment 88 is the custom tool of Embodiment 86, wherein the first mold boy further includes a second interproximal portion, wherein the second mold body further includes a second interproximal portion, wherein the second interproximal portion of the first mold body has a first thickness measured along the mesial-distal axis and the second interproximal portion of the second mold body has a second thickness measured along the mesial-distal axis and wherein the first thickness is less than the second thickness.

Embodiment 89 is the custom tool of Embodiment 88, wherein the first thickness is less than the second thickness.

Embodiment 90 is the custom tool of Embodiments 86-89, wherein the first mold body and second mold body are two separate portions which combine together in the mouth of the patient.

Embodiment 91 is the custom tool of Embodiment 90, wherein the custom tool further includes a hinge portion to connecting the first mold body and the second mold body.

Embodiment 92 is the custom tool of Embodiments 86-91, wherein the first mold body and second mold body form a one-piece, monolithic, integrally formed mold body.

Embodiment 93 is the custom tool of Embodiments 86-92, wherein the tool comprises silicone.

Embodiment 94 is the custom tool of Embodiments 86-93, wherein the first interproximal portion of the first mold body and the first interproximal portion of the second mold body are aligned with one another along the occlusal-gingival axis.

Embodiment 95 is the custom tool of Embodiments 86-94, wherein the first interproximal portion includes a length measured along a occlusal-gingival axis and a thickness measured along a mesial-distal axis, and wherein the length to thickness ratio >5.

Embodiment 96 is the custom tool of Embodiments 86-95, wherein the first interproximal portion includes a length measured along an occlusal-gingival axis and a depth measured along the facial-lingual axis, and wherein the length to depth ratio >5.

Embodiment 97 is a custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of the tooth: a second mold body providing for a customized fit with at least one tooth of the patient, wherein the second mold body includes a portion corresponding with at least a second surface of the tooth and a first interproximal portion corresponding with the first interproximal surface of the tooth, wherein the first interproximal portion of the first mold body includes a first region, a second region, and a third region along the occlusal-gingival axis and wherein the first interproximal portion of the second mold body includes a first region, a second region, and a third region and wherein the second region of the first interproximal portion of the first mold body includes a portion of an aperture and the second region of the first interproximal portion of the second mold body includes another portion of the aperture 91.

Embodiment 98 is the custom tool of Embodiment 97, wherein the first mold body and second mold body are two separate portions which combine together in the mouth of the patient.

Embodiment 99 is the custom tool of Embodiment 92, wherein the custom tool further includes a hinge portion to connecting the first mold body and the second mold body.

Embodiment 100 is the custom tool of Embodiment 97, wherein the first mold body and second mold body form a one-piece, monolithic, integrally formed mold body.

Embodiment 101 is the custom tool of Embodiments 9-100, wherein the first interproximal portion includes a length measured along a occlusal-gingival axis and a thickness measured along a mesial-distal axis, and wherein the length to thickness ratio >5.

Embodiment 102 is the custom tool of Embodiments 97-101, wherein the first interproximal portion includes a length measured along a occlusal-gingival axis and a depth measured along the facial-lingual axis, and wherein the length to depth ratio >5.

Embodiment 103 is the custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of the tooth, a second mold body providing for a customized fit with the at least one tooth of the patient, wherein the second mold body includes a portion corresponding with at least a second surface of the tooth and a first interproximal portion corresponding with the first interproximal surface of the tooth, wherein the first interproximal portion of the first mold body includes a first region and a second region and wherein the first interproximal portion of the second mold body includes a first region and a second region, wherein the first regions of the first interproximal portion of both the first and second mold bodies includes a first depth measured along the facial-lingual axis, wherein the second regions of the first interproximal portion of both the first and second mold bodies includes a second depth measured along the facial-lingual axis, wherein the second depth is less than the first depth.

Embodiment 104 is the custom tool of Embodiment 103, wherein the second regions of the first interproximal portion of both the first and second mold bodies include a curved surface.

Embodiment 105 is the custom tool of Embodiment 97, wherein the first region of the first interproximal portion of both the first and second mold bodies have matched planar portions.

Embodiment 106 is the custom tool of Embodiment 103, wherein the first mold body and second mold body are two separate portions which combine together in the mouth of the patient.

Embodiment 107 is the custom tool of Embodiment 106, wherein the custom tool further includes a hinge portion to connecting the first mold body and the second mold body.

Embodiment 108 is the custom tool of Embodiments 103-107, wherein the first mold body and second mold body form a one-piece, monolithic, integrally formed mold body.

Embodiment 109 is the custom tool of Embodiments 103-108, wherein the first interproximal portion includes a length measured along a occlusal-gingival axis and a thickness measured along a mesial-distal axis, and wherein the length to thickness ratio >5.

Embodiment 110 is the custom tool of Embodiment 103-109, wherein the first interproximal portion includes a length measured along a occlusal-gingival axis and a depth measured along the facial-lingual axis, and wherein the length to depth ratio >5.

Embodiment 111 is the custom tool for forming a dental restoration in a mouth of a patient, the custom tool comprising: a first mold body providing for a customized fit with at least one tooth of the patient having a first interproximal space and a second interproximal space opposite the first interproximal space, wherein the first mold body includes a portion corresponding with at least a first surface of the tooth and a first interproximal portion corresponding with a first interproximal surface of the tooth and a second interproximal portion corresponding with the second interproximal surface of the tooth, wherein the first interproximal portion of the first mold body includes a thickness measured along the mesial-distal axis and such thickness is narrower than a first interproximal space and the second interproximal portion of the first mold body includes a thickness measured along the mesial distal axis and such thickness is narrower than the second interproximal space measured along the mesial-distal axis, wherein the first mold body is configured to combine with the tooth of the patient to form a mold cavity encompassing a portion of missing tooth structure of the tooth, wherein the first portion of the missing tooth structure includes missing interproximal tooth structure.

Embodiment 112 is the custom tool of Embodiment 111, further including a second mold body providing for a customized fit with the at least one tooth of the patient having the first interproximal space and the second interproximal space opposite the first interproximal space, wherein the second mold body includes a portion corresponding with at least a second surface of the tooth and a first interproximal portion corresponding with the first interproximal surface of the tooth and the second interproximal portion corresponding with the second interproximal surface of the tooth.

Embodiment 113 is the custom tool of Embodiment 111, wherein the first mold body and second mold body are two separate portions which combine together in the mouth of the patient.

Embodiment 114 is the custom tool of Embodiment 113, wherein the custom tool further includes a hinge portion to connecting the first mold body and the second mold body.

Embodiment 115 is the custom tool of Embodiment 111, wherein the first mold body and second mold body form a one-piece, monolithic, integrally formed mold body.

Embodiment 116 is the custom tool of Embodiments 111-115, wherein the at least one tooth of the patient includes a long axis through the crown and root of the tooth where the build of the tooth is most symmetrically arranged, and wherein the long axis of the at least one tooth does not change when the custom tool is in contact with the tooth.

Embodiment 117 is the custom tool for forming a dental restoration in a mouth of a patient, the custom tool comprising: a first mold body providing for a customized fit with at least one tooth of the patient, wherein the first mold body includes a portion corresponding with at least a first surface of the tooth and a first interproximal portion corresponding with a first interproximal surface of a scanned three-dimensional image of the tooth of the patient and a second interproximal portion corresponding with the second interproximal surface of a tooth selected or synthesized from geometric data not affiliated with the patient; and a second mold body providing for a customized fit with the at least one tooth of the patient, wherein the second mold body includes a portion corresponding with a second surface of the tooth, a first interproximal portion corresponding with a first interproximal surface of a scanned three-dimensional image of the tooth of the patient and a second interproximal portion corresponding with the second interproximal surface of a tooth selected or synthesized from geometric data not affiliated with the patient; and wherein the first mold body and second mold body are configured to combine with the tooth of the patient to form a mold cavity encompassing a portion of missing tooth structure of the tooth, and wherein a first portion of the missing tooth structure includes missing interproximal tooth structure.

Embodiment 118 is the custom tool of Embodiment 117, wherein the second interproximal portion is based on based on anatomical averages and algorithms.

Embodiment 119 is the custom tool of Embodiment 117, wherein the second interproximal portion is based on digitally stored images in a library of images.

Embodiment 120 is the custom tool of Embodiment 117, wherein the first interproximal portion is selected from existing contact from a patient scan, a contact in a digital wax up, a contact below a lengthen contact in a wax up, a contact based on doctor preference, or an open contact.

Embodiment 121 is the custom tool of Embodiment 117, wherein the second interproximal portion is selected from existing contact from a patient scan, a contact in a digital wax up, a contact below a lengthen contact in a wax up, a contact based on doctor preference, an open contact or based on a different set of geometrical rules or algorithms.

1. A custom tool for forming a dental restoration in a mouth of a patient, the custom tool comprising:
a first mold body providing for a customized fit with at least one tooth of the patient, wherein the first mold body includes a portion corresponding with at least a first surface of the tooth and a first interproximal portion corresponding with a first interproximal surface of the tooth and a second interproximal portion corresponding with the second interproximal surface of the tooth; and
a second mold body providing for a customized fit with the at least one tooth of the patient, wherein the second mold body includes a portion corresponding with a second surface of the tooth, and a first interproximal portion corresponding with a first interproximal surface of the tooth and a second interproximal portion corresponding with the second interproximal surface of the tooth,
wherein the first interproximal portion of the first mold body includes a first region and a second region along the occlusal-gingival axis and
wherein the first interproximal portion of the second mold body includes a first region and a second region along the occlusal-gingival axis and
wherein the first region of the first interproximal portion of the first mold body is designed to correspond with the first region of the first interproximal portion of the second mold body; and
wherein the second region of the first interproximal portion of the first mold body is designed to correspond with the second region of the first interproximal portion of the second mold body.

2. The custom tool of claim 1, wherein the first region of the first interproximal portion of the first mold body is designed to mate with the first region of the first interproximal portion of the second mold body; and
wherein the second region of the first interproximal portion of the first mold body is designed to mate with the second region of the first interproximal portion of the second mold body.

3. The custom tool of claim 1, wherein the first interproximal portion of the first mold body further includes a third region along the occlusal-gingival axis and
wherein the second interproximal portion of the first mold body includes a third region along the occlusal-gingival axis;
wherein the first interproximal portion of the second mold body includes a third region along the occlusal-gingival axis;
wherein the second interproximal portion of the second mold body includes a third region along the occlusal-gingival axis;
wherein the third region of the first interproximal portion of the first mold body is designed to correspond with the third region of the first interproximal portion of the second mold body.

4. The custom tool of claim 3, wherein the third region of the first interproximal portion of the first mold body is designed to mate with the third region of the first interproximal portion of the second mold body.

5. The custom tool of claim 3, wherein the first regions of the first interproximal portion of both the first and second mold bodies includes a first thickness measured along the mesial-distal axis, wherein the second regions of the first interproximal portion of both the first and second mold bodies includes a second thickness measured along the mesial-distal axis, wherein the third regions of the first interproximal portions of both the first and second mold bodies includes a third thickness measured along the mesial-distal axis, wherein the second thickness is less than the first thickness and less than the third thickness.

6. The custom tool of claim 5, wherein the first interproximal portion of the first mold body includes a first region, a second region and a third region along the occlusal-gingival axis and wherein the first interproximal portion of the second mold body includes a first region, a second region, and a third region along the occlusal-gingival axis, and wherein the second region of the first interproximal portion of the first mold body includes a portion of an aperture and the second region of the first interproximal portion of the second mold body includes another portion of the aperture.

7. The custom tool of claim 5, wherein the first interproximal portion of the first mold body includes a first region, a second region along the occlusal-gingival axis and wherein the first interproximal portion of the second mold body includes a first region, a second region along the occlusal-gingival axis, and wherein the second region of the first interproximal portion of the first mold body includes a portion of an aperture and the second region of the first interproximal portion of the second mold body includes another portion of the aperture, such that no portion of the second regions of the first and second mold bodies are in contact within the first interproximal portion.

8. The custom tool of claim 1, wherein the first region of the first interproximal portion includes a first thickness measured along the mesial-distal axis and wherein the second region of the first interproximal portion includes a second thickness measured along the mesial-distal axis, and wherein the first thickness is less than the second thickness.

9. The custom tool of claim 1, wherein the second interproximal portion of the first mold body includes a first region and a second region along the occlusal-gingival axis, wherein the first region includes a first thickness measured along the mesial-distal axis and wherein the second region includes a second thickness measured along the mesial-distal axis, and wherein the first thickness is less than the second thickness.

10. The custom tool of claim 1, wherein the first interproximal portion of the first mold body includes a first region and a second region and wherein the first interproximal portion of the second mold body includes a first region and a second region, wherein the first regions of the first interproximal portion of both the first and second mold bodies includes a first depth measured along the facial-lingual axis, wherein the second regions of the first interproximal portion of both the first and second mold bodies includes a second depth measured along the facial-lingual axis, wherein the second depth is less than the first depth.

11-13. (canceled)

14. A custom tool for forming a dental restoration in a mouth of a patient, the custom tool comprising:
a first mold body providing for a customized fit with at least one tooth of the patient, wherein the first mold body includes a portion corresponding with at least a first surface of the tooth and a first interproximal portion corresponding with a first interproximal surface of the tooth,
wherein the first interproximal portion of the first mold body includes a first region and a second region along the occlusal-gingival axis, and
wherein the first region has a first thickness measured along the mesial-distal axis and second region has a second thickness measured along the mesial-distal axis and wherein the first thickness is different than the second thickness.

15. The custom tool of claim 14, wherein the first thickness is less than the second thickness.

16. The custom tool of claim 14 further including a second mold body providing for a customized fit with at least one tooth of the patient, wherein the second mold body includes a portion corresponding with at least a first surface of the tooth and a first interproximal portion corresponding with a first interproximal surface of the tooth,
wherein the first interproximal portion of the second mold body includes a first region and a second region along the occlusal-gingival axis, and
wherein the first region has a first thickness measured along the mesial-distal axis and second region has a second thickness measured along the mesial-distal axis and wherein the first thickness is different than the second thickness.

17. The custom tool of claim 16, wherein the first thickness is less than the second thickness.

18. The custom tool of claim 14, wherein the first interproximal portion of the first mold body includes a third region along the occlusal-gingival axis and wherein the first interproximal portion of the second mold body includes a third region along the occlusal-gingival axis, wherein the first regions of the first interproximal portion of both the first and second mold bodies includes a first thickness measured along the mesial-distal axis, wherein the second regions of the first interproximal portion of both the first and second mold bodies includes a second thickness measured along the mesial-distal axis, wherein the third regions of the first interproximal portions of both the first and second mold bodies includes a third thickness measured along the mesial-distal axis, wherein the first thickness is less than the second thickness, and the second thickness is less than the third thickness.

19. The custom tool of claim 1, wherein the second interproximal portion of the first mold body includes a third region and wherein the second interproximal portion of the second mold body includes a third region, wherein the first regions of the second interproximal portion of both the first and second mold bodies includes a first thickness measured along the mesial distal axis, wherein the second regions of the second interproximal portion of both the first and second mold bodies includes a second thickness measured along the mesial-distal axis, wherein the third regions of the second interproximal portions of both the first and second mold bodies includes a third thickness measured along the mesial-distal axis, wherein the first thickness is less than the second thickness, and the second thickness is less than the third thickness.

20. A custom tool for forming a dental restoration in a mouth of a patient, the custom tool comprising:
a first mold body providing for a customized fit with at least one tooth of the patient, wherein the first mold body includes a portion corresponding with at least a first surface of the tooth and a first interproximal portion corresponding with a first interproximal surface of the tooth;
a second mold body providing for a customized fit with at least one tooth of the patient, wherein the second mold body includes a portion corresponding with at least a second surface of the tooth and a first interproximal portion corresponding with the first interproximal surface of the tooth,
wherein the first interproximal portion of the first mold body includes a first region, a second region, and a third region along the occlusal-gingival axis and wherein the first interproximal portion of the second mold body includes a first region, a second region, and a third region and wherein the second region of the first interproximal portion of the first mold body includes a portion of an aperture and the second region of the first interproximal portion of the second mold body includes another portion of the aperture.

21. The custom tool of claim 20, wherein the first mold body and second mold body are two separate portions which combine together in the mouth of the patient.

22. The custom tool of claim 20, wherein the first mold body and second mold body form a one-piece, monolithic, integrally formed mold body.

23. The custom tool of claim 20, wherein the first interproximal portion includes a length measured along an occlusal-gingival axis and a thickness measured along a mesial-distal axis, and a depth measured along the facial-lingual axis, and wherein at least one of (i) the length to depth ratio is greater than 5, and (ii) the length to thickness ratio is greater than 5.

24. (canceled)
